(19) United States
(12) Patent Application Publication
(10) Pub. No.: US 2025/0306503 A1
(43) Pub. Date: Oct. 2, 2025

(54) CARTRIDGE AND DEVELOPING DEVICE

(71) Applicant: CANON KABUSHIKI KAISHA, Tokyo (JP)

(72) Inventors: TOMOFUMI KAWAMURA, Shizuoka (JP); YUKIHIDE ITO, Kanagawa (JP); RYOTA OOKA, Shizuoka (JP); TAICHI SATO, Kanagawa (JP); JUN HARA, Kanagawa (JP); SHUHEI KAWASAKI, Shizuoka (JP); TSUBASA YOSHIDA, Chiba (JP)

(21) Appl. No.: 19/087,030

(22) Filed: Mar. 21, 2025

(30) Foreign Application Priority Data
Mar. 29, 2024 (JP) 2024-055648
Mar. 29, 2024 (JP) 2024-057908

(51) Int. Cl. G03G 15/08; G03G 21/18

(52) U.S. Cl. CPC G03G 15/0889; G03G 15/0882; G03G 15/0891; G03G 21/1814; G03G 21/1842; G03G 2215/0687; G03G 2215/085

(57) ABSTRACT

When a cartridge is in a posture in which it is installed in an image forming apparatus and used for image formation, a developing chamber is positioned below a storage chamber. At least a portion of an opening is located above a supply roller. A stirring shaft is located above the opening. A second stirring sheet member is provided on the side opposite to a first stirring sheet member with respect to an imaginary line passing through the center of rotation of the stirring shaft. The first stirring sheet member and the second stirring sheet member each have a length that allows the other ends thereof to reach the opening when the stirring shaft rotates.

### BACKGROUND OF THE INVENTION

### Field of the Invention

The present invention relates to a cartridge and a developing device, the cartridge being configured to be installed in an image forming apparatus and used to form an image onto a recording medium.

### Description of the Related Art

In the related art, image forming apparatuses using an electrophotographic image forming process employ a cartridge system that allows cartridges, such as developing cartridges and process cartridges, to be used by being attached and detached to and from a main body of the image forming apparatus. As an example of a developing device of such a cartridge, there is a developing device including a developing chamber, which is provided with a developing roller and a developer-supplying roller, and a developer storage chamber, which stores a developer, and the developing device has an opening that connects the developing chamber and the developer storage chamber, which are otherwise isolated from each other.

Japanese Patent Laid-Open No. 2022-130369 proposes a configuration in which a developing chamber is disposed below a developer storage chamber and in which a developer is conveyed to the developing chamber by a stirring member, which is disposed in the developer storage chamber.

### SUMMARY OF THE INVENTION

A cartridge according to an aspect of the present invention is a cartridge configured to be installed in an image forming apparatus and used for image formation, the cartridge including a storage chamber that stores a toner, a developing roller that is configured to be rotatable and that carries the toner, a supply roller that is configured to be rotatable and that supplies the toner to the developing roller, a developing chamber that communicates with the storage chamber via an opening and in which the developing roller and the supply roller are arranged, and a stirring member that is disposed in the storage chamber and that stirs the toner. The stirring member includes a stirring shaft that rotates, a first stirring sheet member that is sheet-shaped, with one end fixed to the stirring shaft and another end being a free end, and a second stirring sheet member that is sheet-shaped, with one end fixed to the stirring shaft and another end being a free end. When viewed in a rotational axis direction of the stirring shaft, and when the cartridge is in a posture in which the cartridge is installed in the image forming apparatus and used for image formation, the developing chamber is positioned below the storage chamber, at least a portion of the opening is located above the supply roller, the stirring shaft is located above the opening, the second stirring sheet member is provided on a side opposite to the first stirring sheet member with respect to an imaginary line passing through a center of rotation of the stirring shaft, and the first stirring sheet member and the second stirring sheet member each have a length that allows the other ends thereof to reach the opening when the stirring shaft rotates.

Further features of the present invention will become apparent from the following description of embodiments with reference to the attached drawings.

### BRIEF DESCRIPTION OF THE DRAWINGS

FIG. 1 is a cross-sectional view illustrating a configuration of a developing device according to a first embodiment of the present invention.

FIG. 2 is a schematic sectional view of an image forming apparatus according to the first embodiment of the present invention.

FIG. 3 is a cross-sectional view of a process cartridge according to the first embodiment of the present invention.

FIG. 4 is a sectional view of the image forming apparatus according to the first embodiment of the present invention.

FIG. 5 is a sectional view of the image forming apparatus according to the first embodiment of the present invention.

FIG. 6 is a sectional view of the image forming apparatus according to the first embodiment of the present invention.

FIG. 7 is an exploded perspective view of a drum unit according to the first embodiment of the present invention.

FIG. 8 is an exploded perspective view of the developing device according to the first embodiment of the invention.

FIG. 9 is an assembly perspective view of the process cartridge according to the first embodiment of the present invention.

FIG. 10 is a perspective view of the process cartridge according to the first embodiment of the present invention.

FIG. 11 is a diagram illustrating a first frame body according to the first embodiment of the present invention.

FIG. 12 is a diagram illustrating a second frame body according to the first embodiment of the present invention.

FIG. 13 is a diagram illustrating a stirring member according to the first embodiment of the present invention.

FIGS. 14A to 14C are diagrams each illustrating a state of a toner in the developing device according to the first embodiment of the present invention.

FIG. 15 is a schematic sectional view of an image forming apparatus according to a second embodiment of the present invention.

FIG. 16 is a schematic cross-sectional view of a developing device according to the second embodiment of the present invention.

FIG. 17 is a schematic cross-sectional view of a developing chamber according to the second embodiment of the present invention.

FIG. 18 is a diagram illustrating an operation of a conveying member according to the second embodiment of the present invention.

FIG. 19 is a diagram illustrating the operation of the conveying member according to the second embodiment of the present invention.

FIG. 20 is a diagram illustrating the operation of the conveying member according to the second embodiment of the present invention.

FIG. 21 is a diagram illustrating the operation of the conveying member according to the second embodiment of the present invention.

FIG. 22 is a diagram illustrating an operation of a conveying member according to a third embodiment of the present invention.

FIG. 23 is a schematic cross-sectional view of a developing device according to Modification 1 of the third embodiment of the present invention.

FIG. 24 is a schematic cross-sectional view of a developing device according to Modification 2 of the third embodiment of the present invention.

FIG. 25 is a schematic cross-sectional view of the developing device according to Modification 2 of the third embodiment of the present invention.

FIG. 26 is a non-drive side view of the developing device according to Modification 2 of the third embodiment of the present invention.

FIGS. 27A and 27B are longitudinal sectional views of the developing device according to Modification 2 of the third embodiment of the present invention.

### DESCRIPTION OF THE EMBODIMENTS

Embodiments of the present invention will be described in detail below with reference to the drawings. Each of the embodiments of the present invention described below can be implemented solely or as a combination of a plurality of the embodiments or features thereof where necessary or where the combination of elements or features from individual embodiments in a single embodiment is beneficial.

Note that, the functions, materials, shapes, dimensions, relative arrangements, and the like of components described in the embodiments should be suitably changed in accordance with the configuration of an apparatus to which the invention is applied and in accordance with various conditions and the like. The scope of the invention is not intended to be limited only to these aspects unless otherwise particularly stated.

### First Embodiment

The first embodiment of the present invention will be described below with reference to the drawings. In the first embodiment, an image forming apparatus in which four process cartridges can be detachably installed will be described as an example of an image forming apparatus.

Note that the number of process cartridges to be installed in the image forming apparatus is not limited to four and may be suitably set as necessary.

In the following embodiments, a laser beam printer will be described as an exemplary aspect of an image forming apparatus.

### Schematic Configuration of Image Forming Apparatus

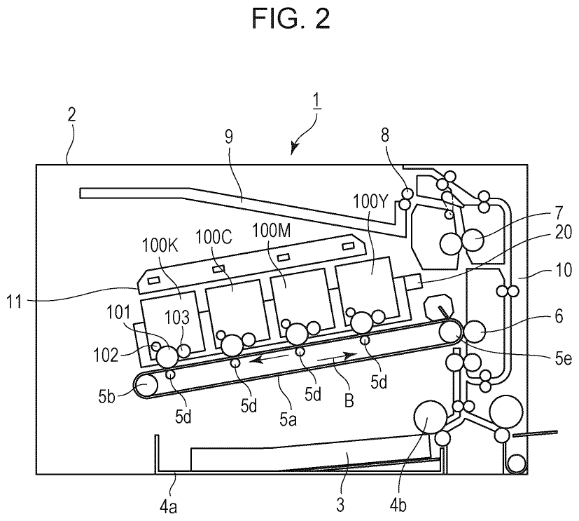

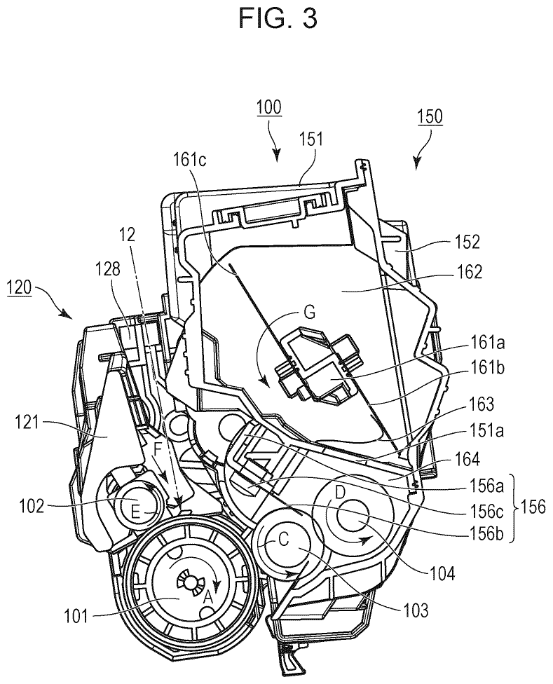

The overall configuration of an electrophotographic image forming apparatus 1 according to the present embodiment (hereinafter referred to as “image forming apparatus 1”) will now be described with reference to FIG. 2. FIG. 2 is a schematic sectional view of the image forming apparatus 1. FIG. 3 is a cross-sectional view of one of process cartridges 100.

The image forming apparatus 1 is a four-color full-color laser beam printer employing an electrophotographic process and performs color image formation onto recording media 3. The image forming apparatus 1 employs a process cartridge system, in which the process cartridges 100 are detachably installed in an image forming apparatus main body 2, and forms color images onto the recording media 3.

Here, the side on which a front door 10 is provided is defined as the front (front surface) of the image forming apparatus 1, and the side opposite to the front is defined as the rear (rear surface) of the image forming apparatus 1. When the image forming apparatus 1 is viewed from the front, the right-hand side is defined as a drive side, and the left-hand side is defined as a non-drive side. The upper side corresponds to the side on which an upper surface the image forming apparatus 1 is located, and the lower side corresponds to the side on which a lower surface the image forming apparatus 1 is located. FIG. 2 is a sectional view of the image forming apparatus 1 as viewed from the non-drive side.

In FIG. 2, the near side corresponds to the front of the image forming apparatus 1, the right-hand side corresponds to the front side of the image forming apparatus 1, and the far side corresponds to the drive side of the image forming apparatus 1.

When viewed in the axial direction of a photoconductor drum, the drive side of the process cartridges 100 corresponds to the side on which a drum coupling member (a photosensitive coupling member), which will be described later, is disposed. When viewed in the axial direction of a developing roller (a developing member), the drive side of the process cartridges 100 corresponds to the side on which a developing coupling member, which will be described later, is disposed.

In the image forming apparatus main body 2, first to fourth process cartridges 100 (100Y, 100M, 100C, and 100K) are arranged in a substantially horizontal direction.

The first to fourth process cartridges 100 (100Y, 100M, 100C, and 100K) have a similar electrophotographic process mechanism and differ from each other in terms of the color and filling amount of developer (hereinafter referred to as “toner”). Accordingly, when it is not particularly necessary to distinguish between them in the following description, they will be described in general terms by omitting the suffixes Y to K.

Each of the first to fourth process cartridges 100 receives a rotational driving force transmitted from a drive output unit (details of which will be described later) of the image forming apparatus main body 2 and receives a bias voltage (a charging bias, a developing bias, a residual electrostatic detection bias, or the like) supplied from a contact of the image forming apparatus main body 2 (not illustrated).

As illustrated in FIG. 3, the process cartridges 100 of the present embodiment each include a photoconductor drum 101 and a drum unit 120. The drum unit 120 includes a charging unit serving as a process unit that acts on the photoconductor drum 101. Here, the drum unit 120 may sometime include not only the charging unit but also a cleaning unit as a process unit.

Each of the process cartridges 100 further includes a developing section (also called a developing device) 150 including a developing unit that develops an electrostatic latent image on the photoconductor drum 101.

The drum unit 120 and the developing device 150 are connected to each other. A more specific configuration of each of the process cartridges 100 will be described later.

In FIG. 2, the first process cartridge 100Y contains yellow (Y) toner in a developing frame body thereof and forms a yellow toner image onto a surface of the corresponding photoconductor drum 101.

Similarly, the second process cartridge 100M contains magenta (M) toner in a developing frame body thereof and forms a magenta toner image onto the corresponding photoconductor drum 101.

The third process cartridge 100C contains cyan (C) toner in a developing frame body thereof and forms a cyan toner image onto the corresponding photoconductor drum 101.

The fourth process cartridge 100K contains black (K) toner in a developing frame body thereof and forms a black toner image on the corresponding photoconductor drum 101.

As illustrated in FIG. 2, a laser scanner unit 11 that serves as an exposure unit is disposed above the first to fourth process cartridges 100. The laser scanner unit 11 outputs laser beams 12 corresponding to image information. The laser beams 12 are caused to scan and irradiate the surfaces of the photoconductor drums 101 by passing through exposure windows 128 of the process cartridges 100.

An intermediate transfer unit 5 that serves as a transfer member is disposed below the first to fourth process cartridges 100. The intermediate transfer unit 5 includes a driving roller 5e and a tension roller 5b, and a transfer belt 5a that has flexibility is stretched between the driving roller 5e and the tension roller 5b.

Portions of the surfaces of the photoconductor drums 101 of the first to fourth process cartridges 100, the portions being located on the lower side, are in contact with an upper surface of the transfer belt 5a. These portions in contact with the upper surface of the transfer belt 5a each serve as a first transfer part. First transfer rollers 5d are arranged in a space enclosed by the transfer belt 5a so as to face their respective photoconductor drums 101.

A second transfer roller 6 is in contact with the driving roller 5e with the transfer belt 5a interposed therebetween. A portion at which the transfer belt 5a and the second transfer roller 6 are in contact with each other serves as a second transfer part.

A feeding unit 4 that includes a sheet feeding tray 4a and a sheet feeding roller 4b is disposed below the intermediate transfer unit 5. The recording media 3 are stacked on top of one another in the sheet feeding tray 4a.

A fixing device 7 and a sheet ejection device 8 are arranged at the upper right in the image forming apparatus main body 2 illustrated in FIG. 2, and the upper surface of the image forming apparatus main body 2 serves as a sheet ejection tray 9.

A toner image is fixed onto one of the recording media 3 by a fixing unit that is included in the fixing device 7, and the recording medium 3 is ejected to the sheet ejection tray 9.

### Image Forming Operation

An image forming operation will now be described with reference to FIG. 2 and FIG. 3. An operation for forming a full-color image is as follows.

The photoconductor drums 101 of the first to fourth process cartridges 100 are each driven so as to rotate at a predetermined speed (in the direction of arrow A in FIG. 3). The transfer belt 5a is also driven so as to rotate in a forward direction (the direction of arrow B in FIG. 2) in accordance with the rotations of the photoconductor drums 101 at a speed corresponding to the speed of the photoconductor drums 101.

The laser scanner unit 11 is driven. In synchronization with the driving of the laser scanner unit 11, in each of the process cartridges 100, a charging roller 102 uniformly charges the surface of the photoconductor drum 101 so that the surface has a predetermined polarity and potential. The laser scanner unit 11 scans and irradiates the surfaces of the photoconductor drums 101 with the laser beams 12 in accordance with different color image signals.

As a result, an electrostatic latent image is formed on the surface of each of the photoconductor drums 101 in accordance with the image signal of the corresponding color. The formed electrostatic latent image is developed by a developing roller 103 that is driven so as to rotate at a predetermined speed in the forward direction (the direction of arrow C in FIG. 3) in accordance with the rotation of the photoconductor drum 101.

By performing an electrophotographic image forming process operation such as that described above, as illustrated in FIG. 2, a yellow toner image that corresponds to a yellow component of a full-color image is formed on the photoconductor drum 101 of the first process cartridge 100Y. Then, the toner image is transferred in a first transfer process onto the transfer belt 5a.

Similarly, a magenta toner image that corresponds to a magenta component of the full-color image is formed on the photoconductor drum 101 of the second process cartridge 100M. Then, the toner image is transferred in the first transfer process so as to be superposed on the yellow toner image, which has already been transferred to the transfer belt 5a.

Similarly, a cyan toner image that corresponds to a cyan component of the full-color image is formed on the photoconductor drum 101 of the third process cartridge 100C. Then, the toner image is transferred in the first transfer process so as to be superposed on the yellow and magenta toner images, which have already been transferred to the transfer belt 5a.

Similarly, a black toner image that corresponds to a black component of the full-color image is formed on the photoconductor drum 101 of the fourth process cartridge 100K. Then, the toner image is transferred in the first transfer process so as to be superposed on the yellow, magenta, and cyan toner images, which have already been transferred to the transfer belt 5a.

In this manner, an unfixed full-color toner image of four colors, which are yellow, magenta, cyan, and black, is formed on the transfer belt 5a.

Meanwhile, in FIG. 2, the recording media 3 are separated one by one and fed at a predetermined control timing. One of the recording media 3 is conveyed to the second transfer part, which is the part where the second transfer roller 6 and the transfer belt 5a are in contact with each other, at a predetermined control timing.

As a result, through a process in which the recording medium 3 is conveyed by passing through the second transfer part, the four color toner images, which are superposed with one another on the transfer belt 5a, are sequentially and collectively transferred onto a surface of the recording medium 3.

The configuration of the image forming apparatus main body 2 will be described in more detail.

### Overview of Process Cartridge Attachment/Detachment Configuration

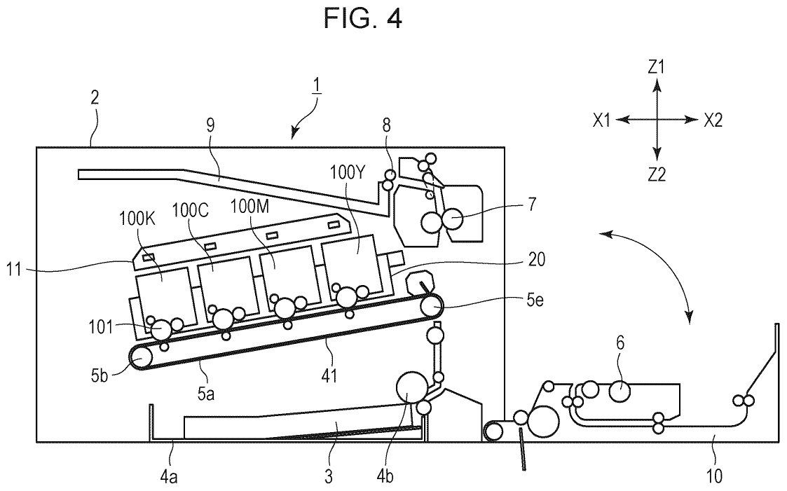

A cartridge tray 20 (hereinafter referred to as “tray 20”) that support the process cartridges 100 will now be described in detail with reference to FIG. 4 to FIG. 6. FIG. 4 is a sectional view of the image forming apparatus 1 with the front door 10 open. In FIG. 4, the tray 20 is positioned inside the image forming apparatus main body 2.

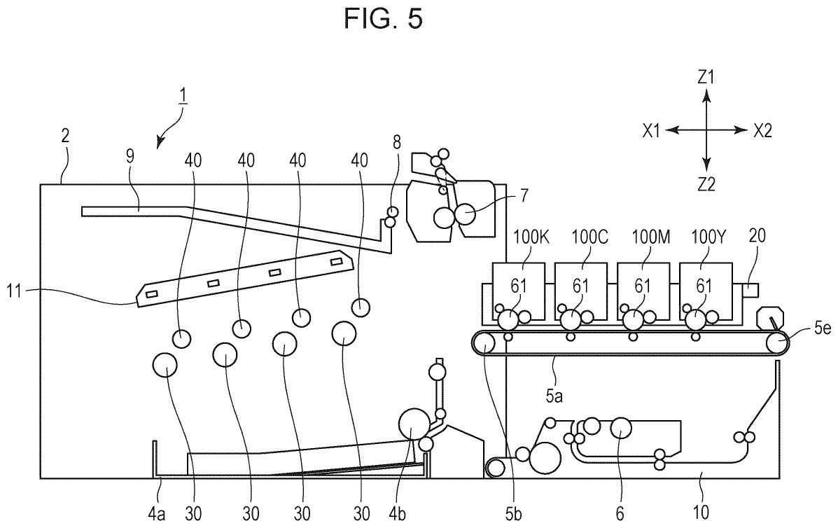

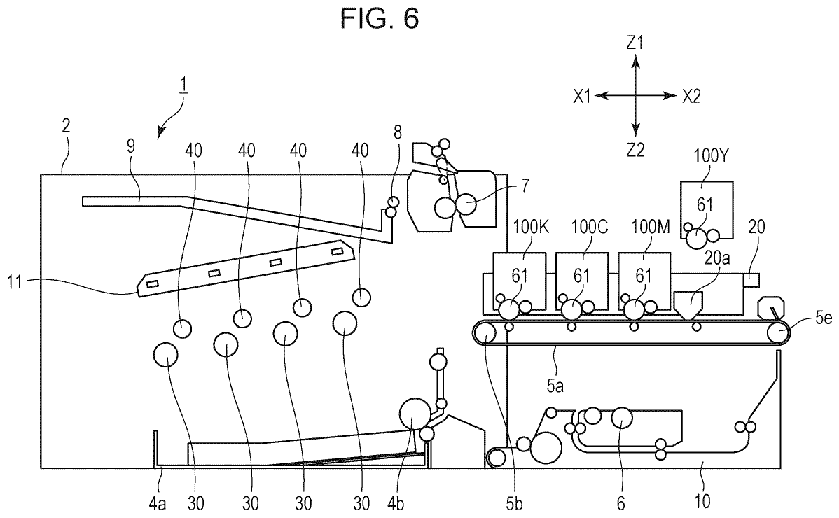

FIG. 5 is a sectional view of the image forming apparatus 1 with the front door 10 open. In FIG. 5, the tray 20 is positioned outside the image forming apparatus main body 2, with the process cartridges 100 accommodated in the tray 20. FIG. 6 is a sectional view of the image forming apparatus 1 with the front door 10 open. In FIG. 6, the tray 20 is positioned outside the image forming apparatus main body 2, with the first process cartridge 100Y removed from the tray 20.

As illustrated in FIG. 4 and FIG. 5, the tray 20 is movable, with respect to the image forming apparatus main body 2 that is installed on a horizontal surface, in the direction of arrow X1 (push-in direction) and the direction of arrow X2 (pull-out direction) which are substantially horizontal directions. In other words, the tray 20 is provided so as to be pullable and pushable with respect to the image forming apparatus main body 2. In a state where the image forming apparatus main body 2 is installed on a horizontal surface as mentioned above, the tray 20 is configured to be movable in a substantially horizontal direction.

Here, the state in which the tray 20 is positioned inside the image forming apparatus main body 2 with the front door 10 open (the state illustrated in FIG. 4) will be referred to as an “inside state”. The state in which the tray 20 is positioned outside the image forming apparatus main body 2 (the state illustrated in FIG. 5) will be referred to as an “outside state”. In the inside state, in which the tray 20 is positioned inside, and the outside state, in which the tray 20 is positioned outside, the photoconductor drums 101 are separated from the transfer belt 5a.

As illustrated in FIG. 6, the tray 20 includes attachment portions 20a, and the first process cartridge 100Y is attachable and detachable to and from a corresponding one of the attachment portions 20a when the tray 20 is in the outside state. (Similarly, the second to fourth process cartridges 100M, 100C, and 100K are each attachable and detachable to and from a corresponding one of the attachment portions 20a of the tray 20.) The process cartridges 100, while being attached to their respective attachment portions 20a, move to the inside of the image forming apparatus main body 2 along with the movement of the tray 20. In the present embodiment, when the front door 10 is closed, the intermediate transfer unit 5 is moved upward in the direction of arrow Z1 by a link mechanism, which is not illustrated, and moved to a position for image formation (a position at which the photoconductor drums 101 is in contact with the transfer belt 5a) (the state illustrated in FIG. 4). In addition, by opening the front door 10, the intermediate transfer unit 5 is lowered in the direction of arrow Z2, so that the photoconductor drums 101 are separated from the transfer belt 5a.

As described above, the tray 20 enables the plurality of process cartridges 100 to collectively move inside the image forming apparatus main body 2 to a position where image formation can be performed and also enables the plurality of process cartridges 100 to be collectively pulled out to the outside of the image forming apparatus main body 2.

### Overall Configuration of Process Cartridge

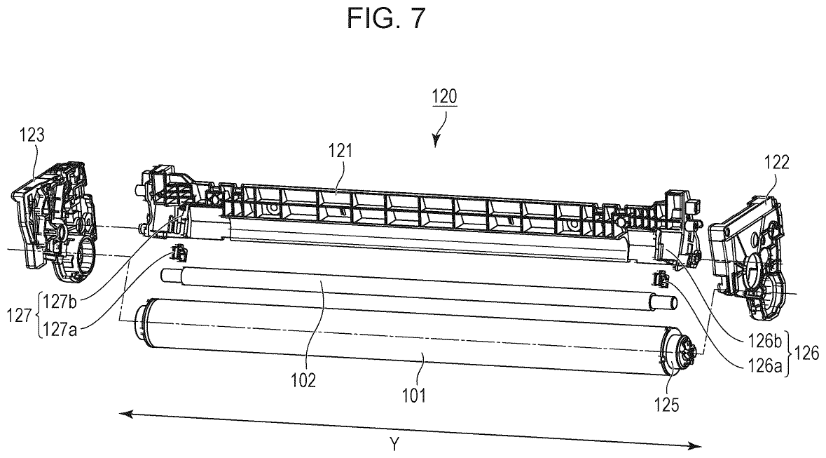

The configuration of each of the process cartridges 100 will now be described with reference to FIG. 7 to FIG. 10.

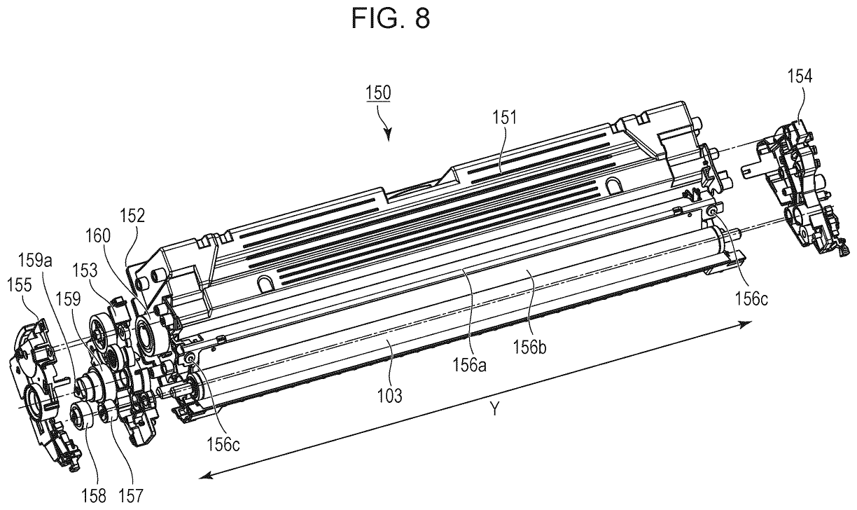

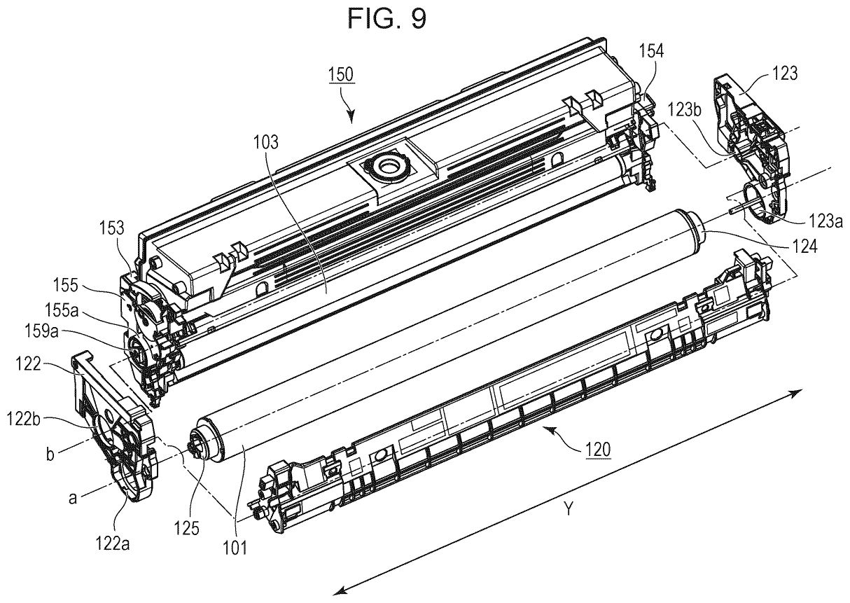

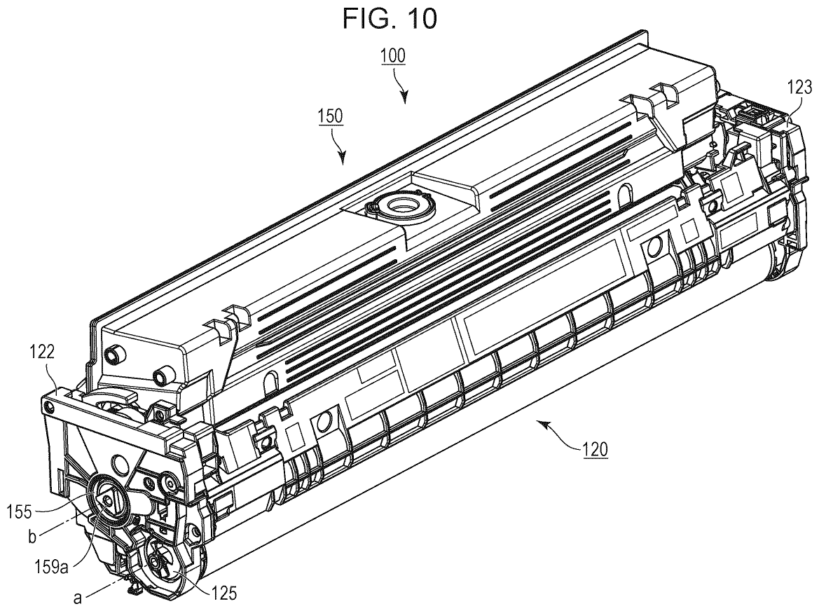

FIG. 7 is an exploded perspective view of one of the drum units 120. FIG. 8 is an exploded perspective view of one of the developing devices 150. FIG. 9 is an assembly perspective view of one of the process cartridges 100 as viewed from the drive side that corresponds to one end side in the axial direction of the corresponding photoconductor drum 101. FIG. 10 is a perspective view of one of the process cartridges 100 as viewed from the drive side.

Each of the process cartridges 100 includes the photoconductor drum 101 and process units that act on the photoconductor drum 101. Here, the process units include the charging roller 102 serving as a charging unit that charges the photoconductor drum 101, the developing roller 103 serving as a developing unit that develops a latent image formed on the photoconductor drum 101, and the like. The process cartridge 100 is divided into the drum unit 120 and the developing device 150.

In the following description, a longitudinal direction Y of the drum unit 120 and the developing device 150 corresponds to a direction substantially parallel to a rotational axis a of the photoconductor drum 101 (FIG. 9).

### Configuration of Drum Unit

As illustrated in FIG. 7, the drum unit 120 includes the photoconductor drum 101, the charging roller 102, and a drum frame body 121. The charging roller 102 is rotatably supported by a drive-side charging roller bearing 126a and a non-drive-side charging roller bearing 127a and biased against the photoconductor drum 101 (in the direction of arrow F in FIG. 3) by pressure springs 126b and 127b. The photoconductor drum 101 is rotatably supported by a drive-side cartridge cover member 122 and a non-drive-side cartridge cover member 123 that are arranged at the opposite ends of the process cartridge 100 in the longitudinal direction of the process cartridge 100.

As illustrated in FIG. 9, a coupling member 125 for transmitting a driving force to the photoconductor drum 101 is provided at one end of the photoconductor drum 101 in the longitudinal direction of the photoconductor drum 101. The coupling member 125 engages with a main-body-side drum driving coupling 30, which serves as a drum driving output unit of the image forming apparatus main body 2, and a driving force of a drive motor (not illustrated) of the image forming apparatus main body 2 is transmitted to the photoconductor drum 101, so that the photoconductor drum 101 is rotated in the direction of arrow A in FIG. 3. In addition, the photoconductor drum 101 includes a drum flange 124 provided at the other end thereof in the longitudinal direction.

As illustrated in FIG. 7, the drive-side charging roller bearing 126a and the non-drive-side charging roller bearing 127a, which support the charging roller 102, are supported by the drum frame body 121 such that the charging roller 102 is capable of being driven and rotated (in the direction of arrow E in FIG. 3) by the photoconductor drum 101 by being brought into contact with the photoconductor drum 101.

### Configuration of Developing Device

As illustrated in FIG. 3, each of the developing devices 150 includes the developing roller 103, a developer-supplying roller 104, a developing blade 156, and a developing frame body.

The developing frame body includes a first developing frame body 151 and a second developing frame body 152. The first developing frame body 151 and the second developing frame body 152 are joined by ultrasonic welding or the like. The developing frame body includes a storage chamber (storage chamber) 162 that stores the toner to be supplied to the developing roller 103.

In addition, as illustrated in FIG. 8, the developing frame body supports the developing roller 103 and the developer-supplying roller 104 via a drive-side bearing 153 and a non-drive-side bearing 154 such that the developing roller 103 and the developer-supplying roller 104 are rotatable, and the developing frame body holds the developing blade 156 that regulates the layer thickness of the toner carried on the circumferential surface of the developing roller 103.

The developing blade 156 is formed by attaching an elastic member 156b, which is a sheet-shaped metal with a thickness of about 0.1 mm, to a support member 156a, which is a metal member having an L-shaped cross section, through welding or similar methods. The developing blade 156 is attached to the developing frame body at two points, which are its two ends in the longitudinal direction thereof, by using fixing screws 156c.

A developing drive input gear 159 for transmitting a driving force to the developing device 150 is provided at one end of the developing device 150 in the longitudinal direction of the developing device 150. The developing drive input gear 159 includes a developing input coupling portion 159a that receives a driving force from a main-body-side developing drive coupling 40 of the image forming apparatus main body 2, and a driving force of a drive motor (not illustrated) of the image forming apparatus main body 2 is input to the developing device 150 via the developing input coupling portion 159a.

The driving force input to the developing device 150 is transmitted to a developing roller gear 157, and this enables the developing roller 103 to rotate in the direction of arrow C in FIG. 3. In addition, the driving force is transmitted to a developer-supplying roller gear 158, and this enables the developer-supplying roller 104 to rotate in the direction of arrow D in FIG. 3. Furthermore, the driving force is transmitted to a stirring gear 160, and this enables a stirring member 161 to rotate in the direction of arrow G in FIG. 3 so as to stir the toner stored in the storage chamber 162.

As illustrated in FIG. 3, the stirring member 161 includes a rotary shaft 161a that extends in a direction in which the rotational axis of the developing roller 103 extends. The stirring member 161 further includes a first stirring sheet (first stirring sheet member) 161b and a second stirring sheet (second stirring sheet member) 161c that serve as conveying members each of which is formed of a flexible sheet. One end of the first stirring sheet 161b and one end of the second stirring sheet 161c are respectively attached to fixing surfaces (a first fixing surface and a second fixing surface) of the rotary shaft 161a, and the other end of the first stirring sheet 161b and the other end of the second stirring sheet 161c are free ends. As the rotary shaft 161a rotates, the first stirring sheet 161b and the second stirring sheet 161c rotate accordingly, thereby stirring the toner. A sealing member 163 is attached to the first stirring sheet 161b via a double-sided adhesive tape, and in a factory default state, a developing opening 151a is sealed by the sealing member 163. The developing opening 151a is an opening that allows communication between a developing chamber 164 and the storage chamber 162.

The sealing member 163 is peeled off from the developing opening 151a as the stirring member 161 rotates. As illustrated in FIG. 8, a developing cover member 155 that supports and covers the developing drive input gear 159 is provided at the one end of the developing device 150 in the longitudinal direction.

### Assembly of Drum Unit and Developing Device

Assembly of the drum unit 120 and the developing device 150 will now be described with reference to FIG. 9. The drum unit 120 and the developing device 150 are coupled to each other by the drive-side cartridge cover member 122 and the non-drive-side cartridge cover member 123, which are arranged at the opposite ends of the process cartridge 100 in the longitudinal direction of the process cartridge 100. The drive-side cartridge cover member 122, which is disposed on the one end side in the longitudinal direction of the process cartridge 100, has a developing-device support hole 122b for supporting the developing device 150 such that the developing device 150 is swingable (movable). Similarly, the non-drive-side cartridge cover member 123, which is disposed on the other end side in the longitudinal direction of the process cartridge 100, has a developing-device support hole 123b for supporting the developing device 150 such that the developing device 150 is swingable. In addition, the drive-side cartridge cover member 122 and the non-drive-side cartridge cover member 123 respectively have drum support holes 122a and 123a for supporting the photoconductor drum 101 such that the photoconductor drum 101 is rotatable. Here, on the one end side, an outer diameter portion of a cylindrical portion 155a of the developing cover member 155 is fitted into the developing-device support hole 122b of the drive-side cartridge cover member 122. On the other end side, an outer diameter portion of a cylindrical portion (not illustrated) of the non-drive-side bearing 154 is fitted into the developing-device support hole 123b of the non-drive-side cartridge cover member 123. In addition, the two ends of the photoconductor drum 101 in the longitudinal direction are fitted into the drum support hole 122a of the drive-side cartridge cover member 122 and the drum support hole 123a of the non-drive-side cartridge cover member 123. The drive-side cartridge cover member 122 and the non-drive-side cartridge cover member 123 are each fixed to the drum unit 120 by using a screw, an adhesive, or the like (not illustrated). As a result, the developing device 150 is supported by the drive-side cartridge cover member 122 and the non-drive-side cartridge cover member 123 such that the developing device 150 is rotatable with respect to the drum unit 120 (the photoconductor drum 101), and during image formation, the developing roller 103 can be positioned at a location at which it acts on the photoconductor drum 101.

Through the above-described steps, the drum unit 120 and the developing device 150 are assembled and integrally formed as the process cartridge 100, as illustrated in FIG. 10.

Note that an axial line connecting the center of the developing-device support hole 122b of the drive-side cartridge cover member 122 and the center of the developing-device support hole 123b of the non-drive-side cartridge cover member 123 will be referred to as a “swing shaft b”. Here, the cylindrical portion 155a of the developing cover member 155 on the one end side is coaxial with the developing input coupling portion 159a. In other words, the developing device 150 is configured to receive a driving force from the image forming apparatus main body 2 at the swing shaft b. In addition, the developing device 150 is rotatably supported about the swing shaft b.

### Detailed Internal Configuration of Developing Device

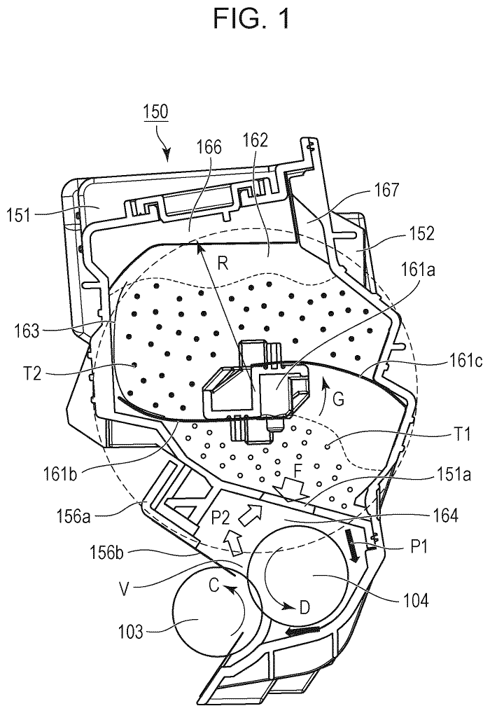

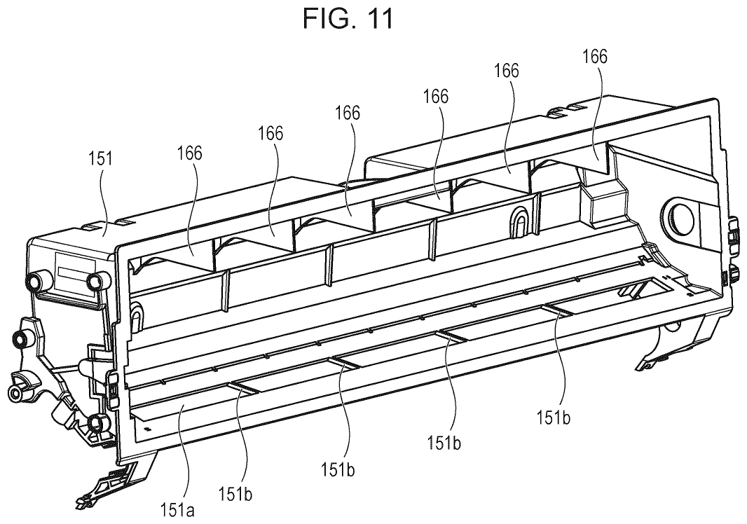

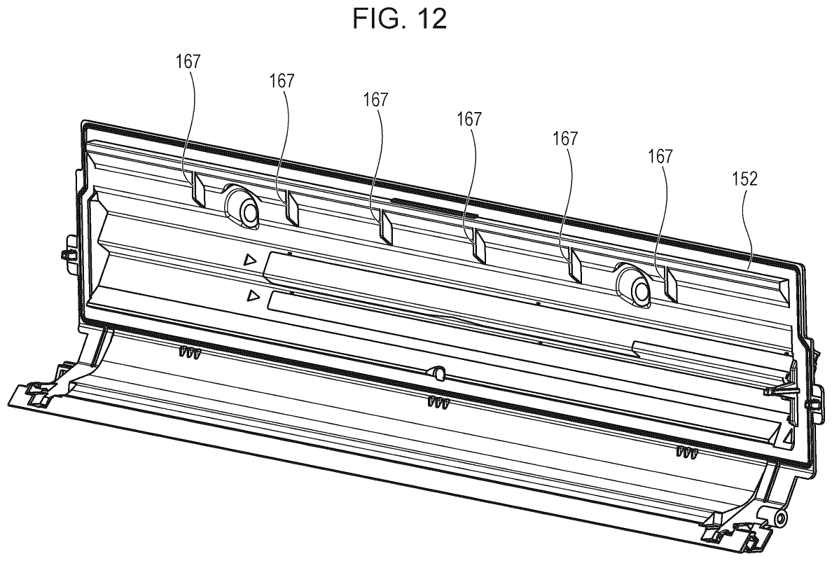

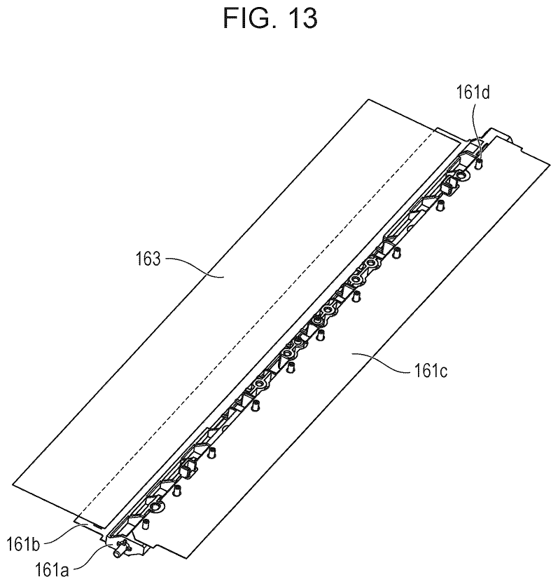

Next, the internal configuration of each developing device will be described in detail with reference to FIG. 1, FIG. 11, FIG. 12, and FIG. 13.

FIG. 1 is a main cross-sectional view of one of the developing devices 150 in the present embodiment. As described above, each of the developing devices 150 includes the first developing frame body 151 and the second developing frame body 152 joined to each other. In each of the developing devices 150, the stirring member 161 is disposed at the center so as to stir the developer at a constant speed. As illustrated in FIG. 13, the stirring member 161 includes the stirring shaft 161a, which rotates, the first stirring sheet 161b, and the second stirring sheet 161c. In the unused state, the sealing member 163 is attached to an end of the first stirring sheet 161b via an attaching unit such as a double-sided adhesive tape.

The first stirring sheet 161b and the second stirring sheet 161c are fixed at positions about 180 degrees out of phase with respect to the stirring shaft 161a by heat staking bosses 161d.

The manufacturing method known as heat staking is a processing technique in which heat is applied to soften a material, which is then the material is sandwiched, pressed, and deformed by using a tool. Thus, when each of the staking bosses 161d is sandwiched and pressurized, it is desirable that two opposing surfaces be flat surfaces. In other words, it is desirable that the fixing surfaces (the first fixing surface and the second fixing surface), to which the first stirring sheet 161b and the second stirring sheet 161c are attached, and an opposing surface that corresponds to each fixing surface and that is to be pressurized simultaneously with each fixing surface during heat staking be both flat surfaces.

In addition, since the stirring member 161 is a rotary member that rotates about the stirring shaft 161a, it is desirable that the stirring member 161 be rotationally symmetrical with respect to the stirring shaft 161a, which is the rotary shaft thereof, as this improves rotational stability.

In other words, the second stirring sheet 161c is provided on the side opposite to the side on which the first stirring sheet 161b is provided with respect to an imaginary line that passes through the center of rotation of the stirring shaft 161a and that is perpendicular to the fixing surface to which the first stirring sheet 161b or the second stirring sheet 161c is fixed.

For the first stirring sheet 161b and the second stirring sheet 161c, a polycarbonate (PC) sheet, a sheet made of a resin such as polyphenylene sulfide (PPS), or the like, with a thickness of 50 μm or more and 200 μm or less is mainly used, and the shape and material are selected so as to satisfy required stirring and circulation performance, as well as durability. In the present embodiment, a PC sheet with a thickness of 130 μm or more and 180 μm or less is used, and the reaction force of the sheet is adjusted by employing a shape of the stirring shaft 161a that separates a ridgeline of the stirring shaft 161a from the staking bosses 161d, thereby balancing the respective performances. The sheet length (short side) in the cross section illustrated in FIG. 1 is set to a value that achieves a rotation radius R of the stirring member 161 illustrated in FIG. 1 and is set so as to enable entry of the sheet into the developing opening 151a, a portion of the first developing frame body 151, and a portion of the second developing frame body 152. The term “enter” refers to a situation where, for example, one component, such as a sheet, reaches a position where it would overlap with another component during movement, such as rotation, unless it deforms. In practice, after one component comes into contact with the other component, the component with lower rigidity bends and deforms. In addition, the sheet length (long side) in the longitudinal direction of the developing device 150 (the direction perpendicular to the plane of FIG. 1) is set to a value longer than the developing opening 151a from the standpoint of the circulation performance.

It is not necessary for the sealing member 163 to have rigidity that is required for stirring the toner, and thus, the thickness of the sealing member 163 is 40 μm to 50 μm, which is equal to or less than the thickness of each of the first and second stirring sheets 161b and 161c. As the material of the sealing member 163, polyethylene terephthalate (PET) that is a material having a flexural modulus lower than that of each of the first and second stirring sheets 161b and 161c may be used.

Note that the sealing member 163 is a member that closes the developing opening 151a and is attached to the end of the first stirring sheet 161b via the attaching unit, such as a double-sided adhesive tape, as mentioned above. Thus, in a direction in which the rotational axis of the stirring shaft 161a extends, the width of the sealing member 163 may be larger than the developing opening 151a and narrower than the width of the first stirring sheet 161b. In the rotational axis direction of the stirring shaft 161a, the width of the sealing member 163 may be smaller than the length of the double-sided adhesive tape in order to ensure that no portion of the sealing member 163 is left unattached to the double-sided adhesive tape.

The configuration of the first developing frame body 151 and the configuration of the second developing frame body 152 will now be described with reference to FIG. 11 and FIG. 12.

The first developing frame body 151 includes first guide ribs 166, and the second developing frame body 152 includes second guide ribs 167, with the first guide ribs 166 and the second guide ribs 167 arranged so as to face each other. As illustrated in FIG. 11 and FIG. 12, the first guide ribs 166 and the second guide ribs 167 are arranged at a plurality of positions along the longitudinal direction and each serve to partially enter and guide each of the first and second stirring sheets 161b and 161c when the stirring member 161 rotates.

In addition, as illustrated in FIG. 11, the developing opening 151a of the first developing frame body 151 is provided with opening crossing ribs 151b arranged at a plurality of positions along the longitudinal direction. When the first stirring sheet 161b and the second stirring sheet 161c come into contact with the developer-supplying roller 104, there is a possibility that an image defect may occur, and thus, the opening crossing ribs 151b are provided in order to prevent the first stirring sheet 161b and the second stirring sheet 161c from entering the developing chamber 164.

Next, toner circulation in the developing device 150 will be described with reference to FIG. 1.

In the developing chamber 164, the developing roller 103 and the developer-supplying roller 104 are arranged so as to be in contact with each other. The developing roller 103 and the developer-supplying roller 104 are driven by the developing roller gear 157 and the developer-supplying roller gear 158, respectively, so as to rotate in the counterclockwise direction (the directions C and D in FIG. 1). The developer-supplying roller 104 is made of a sponge material and has functions of storing the toner conveyed in a direction P1 by the stirring member 161 therein and supplying the toner to the developing roller 103. In addition, when the developer-supplying roller 104 comes into contact with the developing roller 103 and becomes deformed (a region V), the developer-supplying roller 104 discharges the toner in a direction P2. Thus, in the developing chamber 164, toner circulation occurs as indicated by arrows P1 and P2. The toner discharged in the direction of arrow P2 passes through the developing opening 151a and returns to the inside of the storage chamber 162.

### Stirring Operation Inside Developing Device

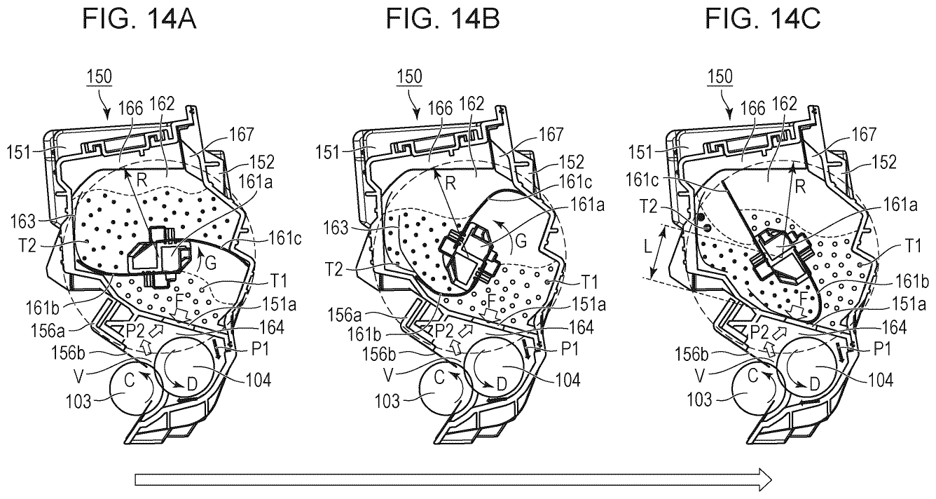

A stirring operation inside each of the developing devices 150 will now be described with reference to FIGS. 14A to 14C.

FIGS. 14A to 14C are diagrams illustrating a stirring operation of one of the stirring members 161 in chronological order. In the present embodiment, as described above, the rotation radius R of the stirring member 161 is set such that the first stirring sheet 161b and the second stirring sheet 161c enter a portion of an inner wall of a container forming the storage chamber 162. Thus, in a phase (a first phase) such as that illustrated in FIGS. 14A and 14B, both the first stirring sheet 161b and the second stirring sheet 161c enter the container, and the toner is divided into two regions (T1 and T2) inside the storage chamber 162 by the stirring member 161. In a phase (a second phase) such as that illustrated in FIG. 14C, only one of the first and second stirring sheets 161b and 161c enters the container.

Here, the developing chamber 164 is located below the storage chamber 162 in the direction of gravity. More specifically, in the present embodiment, in a posture in which the process cartridge 100 is mounted to the image forming apparatus 1, the upper end of the developing opening 151a is located above the developer-supplying roller 104, and the rotary shaft 161a of the stirring member 161 is located above the developing opening 151a. In this case, a toner powder pressure F within the storage chamber 162 acts on the developing opening 151a. In particular, in the case where the stirring member 161 is not provided in the storage chamber 162 or in the case where the number of stirring sheets provided in the storage chamber 162 is one, the toner powder pressure F is large, so that it is difficult to return a sufficient amount of the toner in the developing chamber 164 to the storage chamber 162, thereby leaving a problem with the circulation performance. However, in the present embodiment, the two stirring sheets are provided, and as illustrated in FIGS. 14A and 14B, there exists a phase in which the two stirring sheets (161b and 161c) simultaneously enter the container. In this case, the stirring member 161 prevents the toner (T2) above the stirring member 161 from falling, and thus, only the toner T1 is present above the developing opening 151a. This can reduce the toner powder pressure F that acts on the developing opening 151a. As a result, a sufficient amount of the toner in the developing chamber 164 can be returned to the storage chamber 162, so that the toner circulation performance in the developing device 150 is improved.

Although the amount of effect is reduced compared with the configuration of the above-described embodiment, in the phase illustrated in FIG. 14A, it is possible to produce an effect even in the case where the rotation radius R of the stirring member 161 is smaller (with shorter stirring sheets) than that illustrated in FIG. 14A and where the stirring sheets do not enter the container. This is because, in the phase illustrated in FIG. 14A, the amount of the toner accumulated on the stirring member 161 in the case where two short stirring sheets are provided is greater than that in the case where a single short stirring sheet is provided. This leads to a relative decrease in the volume of the toner T2 and a reduction in the toner powder pressure F acting on the developing opening 151a. Thus, with or without entry of a stirring sheet into the container, the toner circulation performance is improved by providing two stirring sheets. Note that the number of stirring sheets is not limited to two, and if a plurality of stirring sheets are provided, the powder pressure F can similarly be reduced compared with the case of a single stirring sheet. Therefore, by providing a plurality of stirring sheets, the circulation performance can be improved.

The lengths (short sides) of the two stirring sheets in the cross sections illustrated in FIGS. 14A to 14C are set to be long enough for the stirring sheets to enter the developing opening 151a. Consequently, when the stirring member 161 rotates, the toner that has accumulated on an edge of the developing opening 151a can be temporarily removed as each of the stirring sheets enters the developing opening 151a, making it easier for the toner in the developing chamber 164 to flow back into the storage chamber 162. In addition, in the phase such as that illustrated in FIG. 4C in which the first stirring sheet 161b has entered the developing opening 151a, since the second stirring sheet 161c is provided on the opposite side of the first stirring sheet 161b, which has entered the developing opening 151a, the toner T1 is suppressed from flowing into a toner T2 region from the right-hand side to the left-hand side in FIG. 4C. In this case, in the phase illustrated in FIG. 4C, the powder pressure F acting on the developing opening 151a is relatively reduced compared with the case of a single stirring sheet (the case where the second stirring sheet 161c in FIG. 4C is not provided). Therefore, the fact that the two stirring sheets (161b and 161c) have a length that allows them to enter the developing opening 151a is, as a result, effective in improving toner circulation.

In addition, as illustrated in FIG. 11 and FIG. 14C, by providing the opening crossing ribs 151b at the developing opening 151a of the first developing frame body 151, it is possible to eliminate the risk that the two stirring sheets may come into contact with the developer-supplying roller 104. Thus, by ensuring a rotational radius length R of each stirring sheet, the toner T2 above the stirring member 161 can be prevented from falling as illustrated in FIG. 14A, and a distance L between the stirring member 161 and the developing opening 151a can be set to a small value. By reducing the distance L, it becomes possible to increase the stirring force of the two stirring sheets as they pass above the developing opening 151a, thereby reducing the toner powder pressure F. Therefore, by providing the opening crossing ribs 151b at the developing opening 151a, the toner circulation performance within the developing device 150 is improved as a result.

As described above, according to the proposed configuration, in a configuration in which the developing chamber 164 is located below the storage chamber 162, the toner powder pressure F acting on the developing opening 151a due to the weight of the toner can be reduced, thereby improving the toner circulation performance within the developing device 150. When the toner circulation performance is improved, deterioration of the toner becomes less likely to progress even if the amount of the toner stored increases, and this enables the cartridge to have a longer service life.

### Second Embodiment

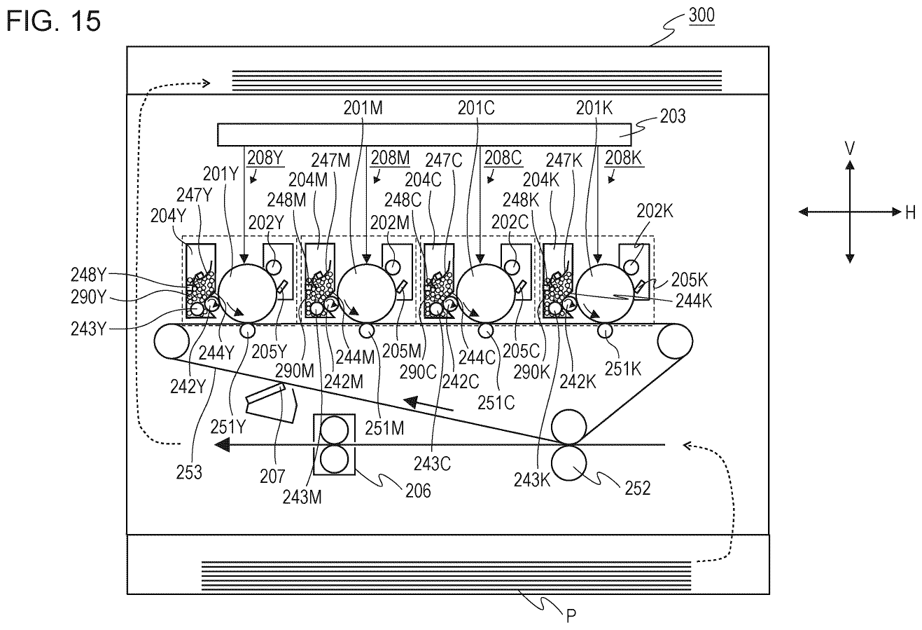

An image forming apparatus according to a second embodiment of the present invention will now be described with reference to the drawings. FIG. 15 to FIG. 23 each illustrate the arrangement of components in a state where the image forming apparatus is placed on a horizontal installation surface, which is a normally assumed installation state of the image forming apparatus. In FIG. 15 to FIG. 23, arrow V indicates the vertical direction (direction of gravity), and arrow H indicates the horizontal direction.

In the second embodiment, an image forming apparatus will be described as an example, in which four process cartridges can be detachably installed as cartridges. Note that the number of process cartridges to be installed in the image forming apparatus is not limited to four and may be suitably set as necessary. In addition, each cartridge is a unit that can be fixed to or detachably installed in the above-described image forming apparatus (the detachable unit is also referred to as a cartridge). Examples of the configuration of the unit include a unit including a process unit (e.g., a charging member, a developing member, a cleaning member or the like) that acts on a photoconductor and a unit containing a toner. In other words, as for the form of the cartridge, various configurations may be employed. Examples include a configuration where an all-in-one cartridge, in which a drum unit and a developing unit are integrated, is replaced, as well as a configuration where a drum unit and a developing unit are replaced separately. Other examples include a configuration where a process cartridge, other than a toner container containing toner, is fixed to the image forming apparatus and where the toner container is replaced by a user when the toner runs out, as well as a configuration where both the toner container and the process cartridge are replaced.

### Overview of Image Forming Apparatus

The overall configuration of the image forming apparatus of the second embodiment and an image forming operation will now be described with reference to FIG. 15. FIG. 15 is a schematic sectional view illustrating a schematic configuration of an image forming apparatus 300. In the second embodiment, image forming stations (hereinafter referred to as “image forming units”) for four colors, which are yellow, magenta, cyan, and black, are arranged side by side from the left-hand side to the right-hand side in FIG. 15. The image forming units are electrophotographic image forming mechanisms having the same configuration, except that the color of the developer (hereinafter referred to as “toner”) 290 stored in each developing device differs. Note that, when it is not particularly necessary to distinguish between the image forming units in the following description, they will be described in general terms by omitting the suffixes Y (yellow), M (magenta), C (cyan), and K (black) from the reference signs, which are used to indicate that the image forming units are elements for their corresponding colors.

Each of the image forming units includes, as main components, a photoconductor drum 201 serving as a photosensitive member, a charging roller 202 serving as a charging unit, a developing device 204, a first transfer device 251, a cleaning member 205, and so forth. An exposure device 203 may be shared by the image forming units or may be provided for each image forming unit.

Each of the photoconductor drums 201 is a rotatable cylindrical photosensitive member and is caused, by a drive motor (not illustrated), which serves as a driving unit, to rotate about its axis in the direction indicated by an arrow shown on each drum in FIG. 15 (the counterclockwise direction). In the second embodiment, each of the photoconductor drums 201 is driven so as to rotate at a rotation speed of, for example, 140 mm/sec on the outer circumferential surface.

The surface of each of the photoconductor drums 201 is uniformly charged by the corresponding charging roller 202. In the second embodiment, each of the charging rollers 202 is a conductive roller in which a conductive rubber layer is provided on a core metal and is disposed parallel to the corresponding photoconductor drum 201 so as to be in contact with the photoconductor drum 201 under a predetermined pressure, so that it rotates along with the rotation of the photoconductor drum 201. In addition, a charging voltage can be applied to each of the charging rollers 202 from a power supply device (not illustrated), which is a power supply unit. In the second embodiment, a direct-current voltage of, for example, −1150 V is applied to each of the charging rollers 202 to charge the photoconductor drums 201, and the surface potential of each of the photoconductor drums 201 in this case is approximately −500 V.

The exposure device 203 that serves as an exposure unit causes laser beams corresponding to image signals to scan the surfaces of the photoconductor drums 201. As a result, electrostatic latent images corresponding to the image signals are formed on the charged surfaces of the photoconductor drums 201. The image signals are input, in response to a request from a user, from, for example, an image reading apparatus (not illustrated) that is connected to a main body of the image forming apparatus 300 or from a host apparatus (not illustrated) such as a personal computer that is communicably connected to the main body of the image forming apparatus 300.

Each of the developing devices 204 deposits the toner 290 that has been charged to the same polarity as the charging polarity of the corresponding photoconductor drum 201 onto a portion (an image portion, an exposed portion) of the surface of the photoconductor drum 201 where electric charge has been attenuated by exposure, so as to form a toner image, which is a developer image. In the second embodiment, each of the developing devices 204 contains the toner 290 as a non-magnetic single-component developer with, for example, a negative normal charging polarity (charging polarity for developing an electrostatic latent image). Each of the developing devices 204 includes a developing roller 242 that is a rotatable developer carrying member, a supply roller 243 that is a rotatable supplying member, and a regulating blade 244 that is a regulating member. Each of the developing rollers 242 comes into contact with the corresponding photoconductor drum 201 so as to form a developing portion and supplies the toner 290, which has been charged to the normal charging polarity, to the photoconductor drum 201 at the developing portion.

Toner images formed on the photoconductor drums 201 are electrostatically transferred onto an intermediate transfer belt 253, which is a transfer-receiving member, by the first transfer devices 251, each of which is one of transfer members. The toner images of different colors are sequentially transferred onto the intermediate transfer belt 253 in such a manner as to be superposed with one another, so that a full-color toner image is formed. Then, the full-color toner image is transferred onto a recording medium P by a second transfer device 252 that is a transfer member different from the first transfer devices 251. After that, the unfixed toner image on the recording medium P is pressurized and heated by a fixing device 206 so as to be fixed onto the recording medium P and ejected as an image-formed product to the outside of the image forming apparatus 300. A belt cleaning device 207 is disposed downstream from the second transfer device 252 in a direction in which the intermediate transfer belt 253 moves, and the belt cleaning device 207 removes and collects the toner 290 remaining on the intermediate transfer belt 253. In contrast, the toner 290 that remains on the surface of each of the photoconductor drums 201 after the first transfer process has been performed is removed and collected by the corresponding cleaning member 205. However, the effects of the present invention are not limited to the above-described configuration. For example, an image-carrier cleanerless system may be employed in which the toner 290 that remains on the surface of each of the photoconductor drums 201 after the first transfer process has been performed is collected by the corresponding developing device 204 without providing dedicated cleaning members for the photoconductor drums 201.

In the second embodiment, the photoconductor drums 201, the charging rollers 202, the developing devices 204, and the cleaning members 205 are integrated with one another so as to form the respective process cartridges 208, and the process cartridges 208 are configured to be attachable to and detachable from an image forming apparatus main body (a portion of the image forming apparatus 300 excluding the process cartridges 208). However, the present invention is not limited to this, and as the process cartridges in the present invention, for example, the developing devices 204 may be configured separately to be attachable to and detachable from the apparatus main body.

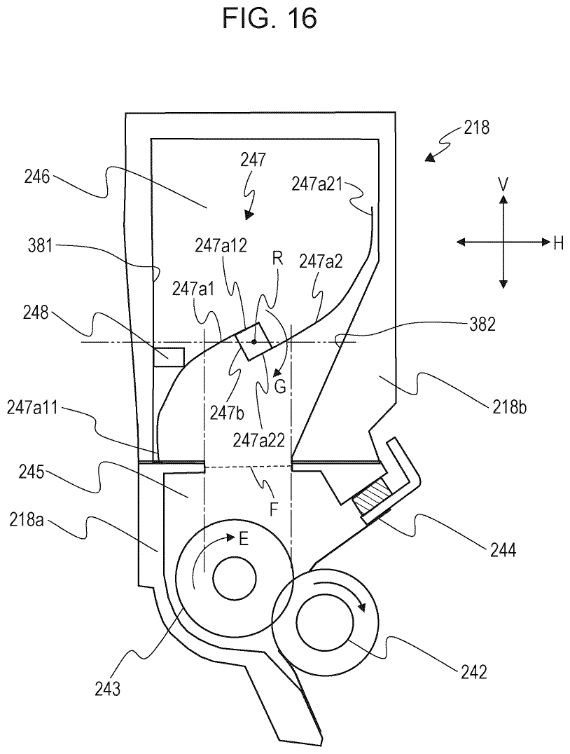

Each of the developing devices 204 of the second embodiment will now be described in detail with reference to FIG. 16. FIG. 16 is a schematic cross-sectional view of one of the developing devices 204 according to the second embodiment.

Each of the developing devices 204 includes a frame body 218. The frame body 218 has a developing chamber 245 and a storage chamber 246 that stores the toner 290 (developer). The frame body 218 includes a first frame 218a that mainly forms the developing chamber 245 and a second frame 218b that mainly forms the storage chamber 246. The storage chamber 246 is located above the developing chamber 245 and communicates with the developing chamber 245 via a communication port F that serves as an opening. In the developing chamber 245, the developing roller 242 serving as a developer carrying member and the supply roller 243 serving as a developer supply member are rotatably arranged. In the storage chamber 246, a toner conveying member 247 for conveying the toner 290 stored in the storage chamber 246 to the developing chamber 245. The communication port F opens in a vertical direction V, and the toner 290 in the storage chamber 246 is fed into the developing chamber 245 in the direction of gravity by an operation of the toner conveying member 247.

The toner conveying member 247 includes a conveying support shaft 247b and sheet portions 247a1 and 247a2. The conveying support shaft 247b is a rotary shaft that is disposed in the storage chamber 246 so as to be rotatable about a rotational axis R, and the sheet portions 247a1 and 247a2 are flexible sheet members. The rotational axis R of the conveying support shaft 247b is parallel to the rotational axis of a rotary member such as the developing roller 242. In a direction crossing the rotational axis R, the sheet portion 247a1 serving as a first sheet member has one end that is a free end 247a11 (a first free end) and the other end that is a fixed end 247a12 (a first fixed end) fixed to the conveying support shaft 247b. Similarly, in the direction crossing the rotational axis R, the sheet portion 247a2 serving as a second sheet member has one end that is a free end 247a21 (a second free end) and the other end that is a fixed end 247a22 (a second fixed end) fixed to the conveying support shaft 247b. The fixed end 247a22 of the sheet portion 247a2 is fixed to the conveying support shaft 247b at a position different from that of the fixed end 247a12 of the sheet portion 247a1.

Inner walls of the storage chamber 246 include a first inner wall 381 and a second inner wall 382 each of which is a region extending in a substantially vertical direction. The first inner wall 381 and the second inner wall 382 are regions that face each other in the horizontal direction perpendicular to the rotational axis R of the conveying support shaft 247b. In the horizontal direction perpendicular to the rotational axis R of the conveying support shaft 247b, the first inner wall 381 is a region located on one side of the conveying support shaft 247b, and the second inner wall 382 is a region located on the other side of the conveying support shaft 247b. The first inner wall 381 is an inner wall region with which a region of the sheet portion 247a1 on the free end 247a11 side and a region of the sheet portion 247a2 on the free end 247a21 side each come into contact as the sheet portions 247a1 and 247a2 move in a direction against gravity due to the rotation of the conveying support shaft 247b. The second inner wall 382 is an inner wall region with which a region of the sheet portion 247a1 on the free end 247a11 side and a region of the sheet portion 247a2 on the free end 247a21 side each come into contact as the sheet portions 247a1 and 247a2 move in the direction of gravity due to the rotation of the conveying support shaft 247b.

In the developing chamber 245 of the developing device 204, the toner 290 is supplied to the surface of the developing roller 242 by the supply roller 243. The toner 290 held on the developing roller 242 (developer carrying member) is then regulated by the regulating blade 244 to control the layer thickness (hereinafter referred to as “layer thickness”) thereof and is formed into a thin layer.

Here, the regulating blade 244 has a function of regulating the layer thickness of the toner 290 on the developing roller 242 and also has a function of serving as a developer charging unit that imparts a predetermined charge to the toner 290 on the developing roller 242. The toner 290 in the form of a thin layer is conveyed, along with the rotation of the developing roller 242, to a contact portion where it comes into contact with the photoconductor drum 201 so as to develop an electrostatic latent image formed on the surface of the photoconductor drum 201. The toner 290 that has not been used for the development and that remains on the developing roller 242 is removed from the developing roller 242 at the contact portion where it comes into contact with the supply roller 243. The removed toner 290 is then stirred and mixed with the toner 290 within the developing device 204.

The developing roller 242 is formed by providing a conductive elastic rubber layer having a predetermined volume resistivity on an outer periphery of a metal core, and in addition, a surface of the developing roller 242 is processed to have a predetermined surface roughness. As the developing roller 242, a single-layer roller or a multi-layer roller may be used. An example of a single-layer roller to be used is a roller in which an elastic layer is formed on a core metal, the elastic layer being made of a rubber material such as silicone rubber, urethane rubber, or hydrin rubber. An example of a multi-layer roller to be used is a roller in which a surface layer is formed by coating the surface of an elastic layer with silicone resin, urethane resin, polyamide resin, fluororesin, or the like. In the second embodiment, in order to achieve an appropriate image density, the developing roller 242 is rotationally driven at a speed such that the movement speed of the surface of the developing roller 242 is, for example, 140% of the movement speed of the surface of the photoconductor drum 201.

The supply roller 243 is an elastic sponge roller in which a conductive foam is formed on the outer periphery of a metal core. The supply roller 243 is disposed so as to come into contact with the developing roller 242 with a predetermined entry amount. Here, in FIG. 16 and the subsequent drawings, the developing roller 242 and the supply roller 243 are illustrated in a partially overlapping manner. This is for the sake of convenience in clearly illustrating the degree of the above-mentioned entry amount. In practice, both the developing roller 242 and the supply roller 243 undergo predetermined elastic deformation according to the predetermined entry amount, resulting in the developing roller 242 and the supply roller 243 being pressed into contact with each other (typically, in a contact state where the supply roller 243 deforms significantly). In the second embodiment, the supply roller 243 including a urethane foam layer and containing an ionic conductive agent is used. As an example, the supply roller 243 of the second embodiment has configuration in which the ionic conductive agent, composed of a salt of a cation and an anion having a reactive functional group that reacts with an isocyanate group, is chemically bonded to the urethane foam layer via the reactive functional group. For example, the supply roller 243 having such a configuration can be manufactured by foaming and curing a urethane composition containing an ionic conductive agent. By making the urethane of the surface layer into an open-cell foam, the toner 290 can be contained within the supply roller 243, enabling stable toner supply to the developing roller 242.

The regulating blade 244 includes a plate-shaped elastic member that is conductive and flexible. One end of the elastic member is fixed to a developing container (a frame) and is supported in a cantilevered manner, while the other end of the elastic member is a free end that comes into contact with the circumferential surface of the developing roller 242. The regulating blade 244 is disposed at a position downstream, in a movement direction (rotational direction) of the surface of the developing roller 242, from an opposing portion (a contact portion) where the supply roller 243 and the developing roller 242 face each other such that the regulating blade 244 is in contact with the circumferential surface of the developing roller 242. In the second embodiment, an SUS material is used as the elastic member of the regulating blade 244. In addition, in the second embodiment, the regulating blade 244 is disposed such that, at the contact position with the developing roller 242, an end portion of the elastic member on the free end side is oriented to the upstream side in the movement direction of the surface of the developing roller 242 (a counter direction).

In addition, predetermined direct-current voltages are applied to the developing roller 242, the supply roller 243, and the regulating blade 244 from a power supply device (not illustrated) in accordance with, for example, an image forming operation. In the second embodiment, voltages corresponding to the temperature and humidity conditions of the image forming apparatus 300 are applied. For example, in an environment with a temperature of 23° C., a direct-current voltage of −350 V is applied to the developing roller 242, and a direct-current voltage of −450 V is applied to both the supply roller 243 and the regulating blade 244. Since the normal charging polarity of the toner 290 in the second embodiment is negative, the potential difference between the supply roller 243 and the developing roller 242 has a polarity that biases (moves) the toner 290 from the supply roller 243 to the developing roller 242. In the present embodiment, the potential difference between the supply roller 243 and the developing roller 242 is variably controlled in accordance with the usage environment and the degree of degradation of the supply roller 243. By this control, stable supply of toner 290 from the supply roller 243 to the developing roller 242 is achieved.

In contrast, the potential difference between the regulating blade 244 and the developing roller 242 has a polarity that biases the toner 290 from the regulating blade 244 to the developing roller 242. This stabilizes the supply of the toner 290 to a contact portion where the regulating blade 244 and the developing roller 242 come into contact with each other and the application of electric charge to the toner 290 by the regulating blade 244.

In the second embodiment, as the toner 290, a non-magnetic, negatively charged toner produced by a suspension polymerization method was used. However, the present invention is not limited to this, and for example, toners produced by other polymerization methods such as pulverization or emulsion polymerization may be used. The volume average particle diameter of the toner 290 may be in the range of 5.0 μm to 8.0 μm. Here, the volume average particle diameter of the toner 290 was measured by using a precision particle size distribution analyzer, Multisizer 3, manufactured by Beckman Coulter, Inc. In the second embodiment, the volume average particle diameter of the toner 290 was approximately 7.0 μm.

In the second embodiment, all of the four color toners 290Y, 290M, 290C, and 290K are toner particles 290 composed of toner base particles 290 containing a release agent, as well as organic silicon polymer on the surfaces of the toner base particles 290. The organic silicon polymer has a T3 unit structure represented by R—Si(O_{1/2})₃, where R denotes an alkyl or phenyl group having 1 to 6 carbon atoms, and the organic silicon polymer forms protrusions on the surface of the toner base particles 290. This creates a spacer effect between the surfaces of the toner base particles 290 and a member such as the developing roller 242, reducing adhesive force. In addition, the protrusions are characterized by their surface contact with the toner base particles 290, and the surface contact is expected to have a significant effect in suppressing movement, detachment, and embedding of the protrusions. Consequently, even in a configuration in which the developing roller 242 is driven while being separated from the photoconductor drum 201, long-term use is possible. Although the toner particles 290 containing organic silicon polymer on the surfaces of the toner base particles 290 was used in the second embodiment, the present invention is not limited to this, and for example, the toner particles 290 that do not contain organic silicon polymer on the surfaces of the toner base particles 290 may be used.

The toner 290 may contain additives (hereinafter referred to as “external additives”), such as flow agents and cleaning aids, in order to improve properties such as flowability, chargeability, and cleaning performance.

Examples of the external additives include fine inorganic oxide particles, such as fine silica particles, fine alumina particles, and fine titanium oxide particles; fine particles of inorganic stearic acid compounds, such as fine aluminum stearate particles and fine zinc stearate particles; and fine particles of inorganic titanate compounds, such as fine strontium titanate and fine zinc titanate. These additives can be used individually or in combinations of two or more. These inorganic fine particles may be surface-treated with an agent such as a silane coupling agent, a titanium coupling agent, a higher fatty acid, or a silicone oil in order to enhance heat-resistant storage stability and environmental stability. In addition, the BET specific surface area of the external additives may be 10 m²/g or more and 450 m²/g or less.

The BET specific surface area can be determined by a low-temperature gas adsorption method using a dynamic constant pressure method in accordance with the BET method (which may be the BET multipoint method). For example, the BET specific surface area (m²/g) can be calculated by adsorbing nitrogen gas onto a surface of a sample using a specific surface area measurement apparatus (trade name: Gemini 2375 Ver. 5.0, manufactured by Shimadzu Corporation) and measuring it in accordance with the BET multipoint method.

The total amount of these various external additives added is 0.05 parts by mass or more and 5 parts by mass or less, and preferably 0.1 parts by mass or more and 3 parts by mass or less, relative to 100 parts by mass of the toner. In addition, a combination of various external additives may be used.

### Toner Circulation in Developing Chamber

The toner circulation in each of the developing chambers 245 when the corresponding supply roller 243 rotates in the direction of arrow E illustrated in FIG. 16 will now be described.

As indicated by one-dot chain lines in FIG. 16, when viewed in the direction of gravity, the conveying support shaft 247b is disposed at a position where it overlaps with the communication port F, and the supply roller 243 is disposed so as to have a portion that overlaps with the communication port F. The toner 290 stored in the storage chamber 246 falls due to its own weight and is conveyed with the rotational driving of the toner conveying member 247 to the developing chamber 245, which is located on the lower side. In addition, the toner 290 in the storage chamber 246 circulates with the rotational driving of the toner conveying member 247 and is suitably conveyed to the vicinity of the communication port F that is indicated by a dotted line in FIG. 16 and that allows communication between the storage chamber 246 and the developing chamber 245. The toner 290 conveyed to the vicinity of the communication port F stays on the surface of the supply roller 243 and inside the supply roller 243. Then, the rotation of the supply roller 243 in the direction of arrow E in FIG. 16 further conveys the toner 290 to a position immediately before a nip that is defined between the supply roller 243 and the developing roller 242. The toner 290 contained on the surface of the supply roller 243 and inside the supply roller 243 is discharged at the nip portion, and part of the toner 290 is coated onto the developing roller 242.

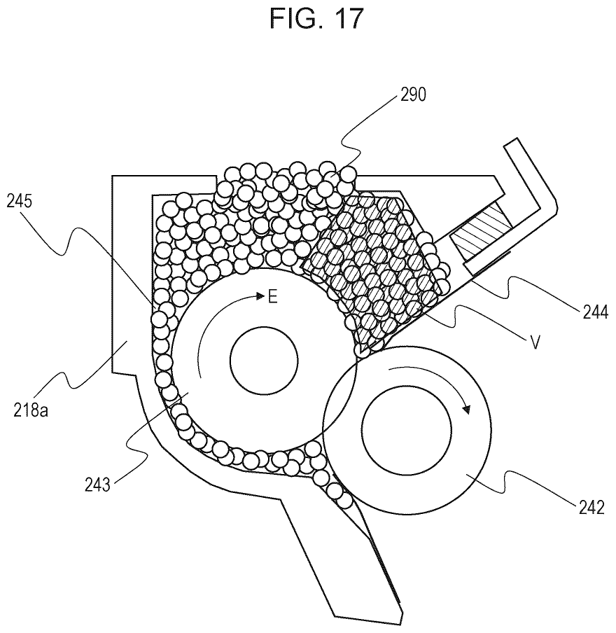

FIG. 17 is a schematic cross-sectional view of one of the developing chamber 245. The toner 290 that has been discharged from the supply roller 243 and that has not been coated onto the developing roller 242 is accumulated in a temporary toner accumulation portion V that is a space located above the developing roller 242 and the supply roller 243 illustrated in FIG. 17. The supply roller 243 also has a function of mechanically scraping off the toner that has been coated onto the developing roller 242. Thus, not only the above-mentioned toner that has not been coated onto the developing roller 242 but also the toner 290 mechanically scraped off from the developing roller 242 are accumulated in the temporary toner accumulation portion V. Here, the mechanical scraping is performed by the supply roller 243 using edge portions of foam cells. Thus, if a large amount of the toner 290 is contained within the supply roller 243, the scraping function is impaired.

In addition, the toner 290 from the storage chamber 246 accumulates above the temporary toner accumulation portion V, and the pressure exerted by the weight of the toner 290 in the storage chamber 246 causes the toner 290 in the temporary toner accumulation portion V to aggregate. This causes the toner 290 in the temporary toner accumulation portion V to become clumped, making it difficult for the toner 290 inside the supply roller 243 to be discharged. Consequently, the amount of the toner contained in the supply roller 243 increases, impairing the scraping function. As a result, the scraping of the toner coated on the surface of the developing roller 242 becomes insufficient, causing an uneven amount of the coated toner in the circumferential direction. This causes a problem of unevenness in density, which is particularly noticeable in, for example, halftone images. Thus, in order to stably form a toner coating, it is necessary to have a configuration that continuously suppresses the accumulation of the toner 290 in the vicinity of the communication port F above the temporary toner accumulation portion V at regular intervals.

### Toner Conveying Member

The toner conveying member 247 of each of the developing devices 204 in the present embodiment will now be described in detail.

As illustrated in FIG. 16, the toner conveying member 247 includes the sheet portions 247a1 and 247a2, each of which has flexibility and serves as a conveying unit for conveying the toner, and the conveying support shaft (rotary shaft) 247b, which is caused to rotate by a rotational driving force supplied from the apparatus main body of the image forming apparatus 300. In the following description, unless it is necessary to distinguish between the sheet portion 247a1 and the sheet portion 247a2, for example, when both sheet portions can be described collectively, they may sometimes be described in general terms by referring them to as the sheet portions 247a.

The conveying support shaft 247b is disposed so as to be substantially parallel to the longitudinal directions (rotational axes directions) of the photoconductor drum 201, the developing roller 242, and the supply roller 243, and so as to be positioned along the entire longitudinal length of the storage chamber 246. Each of the sheet portions 247a is a continuous sheet (plate-shaped member) that extends over substantially the entire longitudinal length (in the rotational axis direction) of the conveying support shaft 247b. Each of the sheet portions 247a is attached to the conveying support shaft 247b at one end portion thereof in a direction (a rotational radial direction, lateral direction) substantially perpendicular to the longitudinal direction of the conveying support shaft 247b. The toner conveying member 247 is rotatably supported by the frame body 218, which forms the storage chamber 246, at its two end portions in the longitudinal direction (rotational axis direction) and is driven so as to rotate in the direction of arrow G in FIG. 16 by a driving unit (a driving source), which is not illustrated.

In the present embodiment, the sheet material used for each of the sheet portions 247a was a polycarbonate (PC) film having a thickness of 150 μm. Note that the thickness of each of the sheet portions 247a may be in the range of 50 μm to 250 μm. The free length of each of the sheet portions 247a is 60 mm, and each of the sheet portions 247a is fixed to the conveying support shaft 247b such that it overlaps with the conveying support shaft 247b by 10 mm. By increasing this overlap amount, the bending amount of each of the sheet portions 247a can be increased. For example, it is also possible to fix each of the sheet portions 247a to another surface of the conveying support shaft 247b to increase the bending amount. Note that, although a quadrangular bar having a quadrangular cross section is used as the conveying support shaft 247b in the present embodiment, the present invention is not limited to this. For example, the conveying support shaft 247b may have a polygonal cross section, a circular cross section, or a composite cross section formed by curves and straight lines as long as the sheet portions 247a can be fixed to it and allowed to rotate.

The material used for the sheet portions 247a and the thickness of each of the sheet portions 247a are not limited to the combination mentioned above in the present embodiment. For example, a polyester film, a polyphenylene sulfide film, a polycarbonate film, or the like may be used as the material, and a combination of such a material and a thickness that allows desired elastic deformation of the sheet portions 247a may be suitably employed.

Here, the sheet portion 247a1 and the sheet portion 247a2 are attached to the conveying support shaft 247b at positions that are 180 degrees apart in the rotational direction. This is an example of an attachment configuration in which, while an end portion of one of the sheet portions 247a1 and 247a2 is in contact with the first inner wall 381 of the storage chamber 246, an end portion of the other is in contact with the second inner wall 382. In the present embodiment, the sheet portion 247a1 is attached to one of a pair of opposite side surfaces of the conveying support shaft 247b, which has a rectangular cross section, such that the sheet portion 247a1 overlaps with the one side surface, and the sheet portion 247a2 is attached to the other of the pair of opposite side surfaces of the conveying support shaft 247b such that the sheet portion 247a2 overlaps with the other side surface. In other words, in the second embodiment, the two sheet portions 247a1 and 247a2 of the toner conveying member 247 are arranged with a 180-degree phase difference. Note that the number of the sheet portions 247a and the arrangement of the sheet portions 247a are not necessarily limited to these. For example, three or more sheet portions 247a may be provided such that the sheet portions 247a adjacent to each other in the rotational direction are arranged with a phase difference other than 180 degrees.

In a state where one of the sheet portions 247a1 and 247a2 is in contact with the first inner wall 381 of the storage chamber 246 and where the other of the sheet portions 247a1 and 247a2 is in contact with the second inner wall 382, the interior of the storage chamber 246 is partitioned into upper and lower spaces by the two sheet portions 247a and the conveying support shaft 247b. In this case, a large part of the toner 290 stored in the storage chamber 246 is held in the upper space of the storage chamber 246 by the sheet portions 247a1 and 247a2 and the conveying support shaft 247b. As a result, the toner 290 in the developing chamber 245 is released from the weight of the toner 290 in the storage chamber 246, or the influence of the weight of the toner 290 in the storage chamber 246 is reduced.

### Configuration of Protrusion of Storage Chamber

As illustrated in FIG. 16, the wall surface (the first inner wall 381) of the storage chamber 246 has a protrusion 248. Here, the protrusion 248 is positioned at the wall surface on the upstream side in the rotational direction of the toner conveying member 247 when viewed from the communication port F between the developing chamber 245 and the storage chamber 246. In other words, among the first inner wall 381 and the second inner wall 382 that are included in the inner wall surface of the storage chamber 246 and that face each other in the horizontal direction perpendicular to the rotational axis R of the conveying support shaft 247b, the first inner wall 381 with which the sheet portions 247a that have passed through the communication port F first come into contact has the protrusion 248.

As indicated by a two-dot chain line in FIG. 16, the closest point of the protrusion 248 to the conveying support shaft 247b of the toner conveying member 247 is located lower than the rotational axis R of the conveying support shaft 247b, which is the center of rotation of the toner conveying member 247. In addition, in the second embodiment, the protrusion 248 is disposed such that each of the sheet portions 247a moving in a direction against gravity comes into contact with the protrusion 248 during the movement thereof in the direction (the first direction).

The first inner wall 381 of the storage chamber 246 is a surface extending in the vertical direction. If the protrusion 248 is not provided, the distance between the first inner wall 381 and the rotational axis R of the conveying support shaft 247b is shortest at a height approximately the same as the rotational axis R of the conveying support shaft 247b. That is to say, the cross-sectional area of a space that is located between the first inner wall 381 and the conveying support shaft 247b and through which each of the sheet portions 247a passes is narrowest at a height approximately the same as the rotational axis R. It can be said that the two-dot chain line in FIG. 16 is an imaginary line tracing the closest distance between the first inner wall 381 and the rotational axis R of the conveying support shaft 247b in the case where the protrusion 248 is not provided. The protrusion 248 is configured to locally narrow the space, which is located between the first inner wall 381 and the conveying support shaft 247b and through which each of the sheet portions 247a passes, to a greater degree. Thus, in the case where the toner 290 is not stored in the storage chamber 246, the bending of each of the sheet portions 247a, which occurs when the sheet portion 247a moves while being in contact with the first inner wall 381, temporarily reaches its maximum at the moment of contact with the protrusion 248. In other words, in the present embodiment, the distance between the first inner wall 381 and the rotational axis R of the conveying support shaft 247b in the direction perpendicular to the rotational axis R is shortest at the protrusion 248. Thus, the timing at which the bending of each of the sheet portions 247a reaches its maximum varies depending on the position at which the protrusion 248 is disposed. In the present embodiment, the protrusion 248 is disposed so as to be located lower than the rotational axis R of the conveying support shaft 247b, so that the timing at which the bending of each of the sheet portions 247a reaches its maximum occurs earlier than it would if the protrusion 248 is not provided.

Note that, regarding the period of time during which each of the sheet portions 247a moves while being in contact with the first inner wall 381, depending on how the sheet portion 247a deforms or its contact state with the protrusion 248 changes, it is possible for the sheet portion 247a to temporarily separate from the first inner wall 381 at a certain moment. For example, the sheet portion 247a may be in a state where it moves onto the protrusion 248, causing the free ends 247a11 and 247a21 to become separated from the first inner wall 381. In the present invention, including such a state, a period of time during which each of the sheet portions 247a moves in a region facing the first inner wall 381 (each of the sheet portions 247a moves in a region where its end comes close to the first inner wall 381) is defined as a first contact period. Similarly, a period of time during which each of the sheet portions 247a comes into contact with the second inner wall 382 or a period of time during which each of the sheet portions 247a moves in a region facing the second inner wall 382 (each of the sheet portions 247a moves in a region where its end comes close to the second inner wall 382) is defined as a second contact period.

Here, as illustrated in FIG. 16, in a case where each of the sheet portions 247a is driven so as to rotate in a direction against gravity while being in contact with the protrusion 248, the sheet portion 247a bends more significantly with respect to the inner wall surfaces other than the protrusion 248. Thus, the stress against bending increases as the entire sheet portion 247a undergoes elastic deformation, thereby increasing a holding force of the upper surface of the sheet portion 247a (the surface on the downstream side in the rotational direction) for holding the toner 90. As a result, when the sheet portion 247a is driven to rotate in the direction against gravity, the period during which the toner 90 is held on the upper surface of the sheet portion 247a is extended, and the accumulation of the toner 90 at the communication port F can be suppressed.

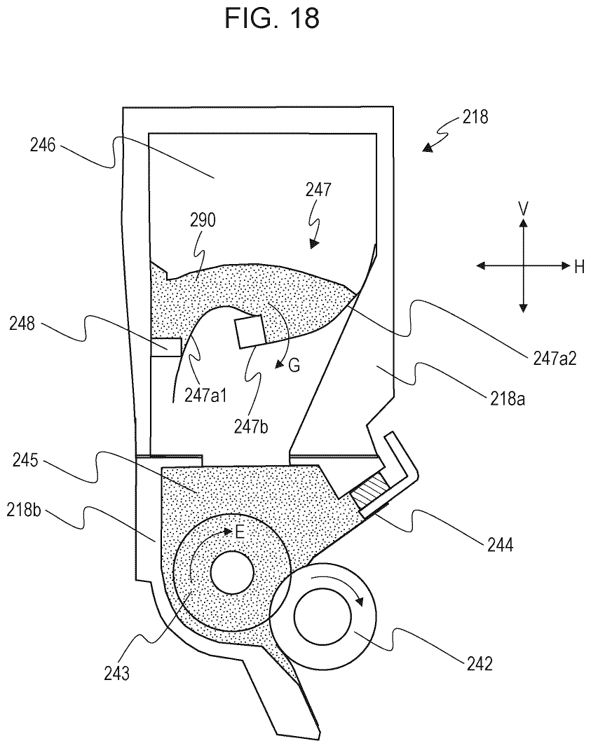

FIG. 18 illustrates a period in which the first contact period during which the sheet portion 247a1 is in contact with the first inner wall 381 or with the protrusion 248, which is a portion of the first inner wall 381, overlaps with the second contact period during which the sheet portion 247a2 is in contact with the second inner wall 382. During this overlapping period, the internal space of the storage chamber 246 is partitioned into the upper and lower spaces by the sheet portions 247a1 and 247a2 and the conveying support shaft 247b. In this state, the sheet portion 247a1 bends more significantly due to contact with the protrusion 248 than it would without contact with the protrusion 248. Accordingly, the timing at which the free end 247a11 of the sheet portion 247a1 reaches approximately the same height as the conveying support shaft 247b occurs later than that in the configuration in which the protrusion 248 is not provided.

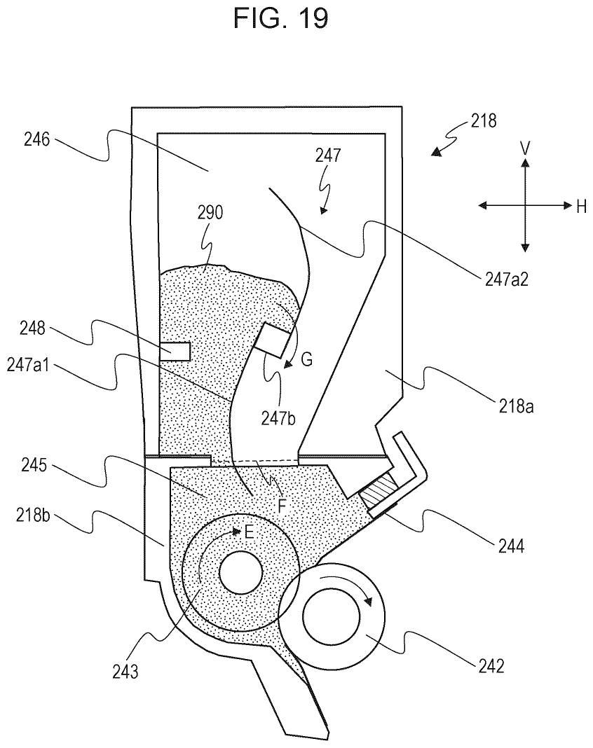

A period before the first contact period is a period during which the movement of the sheet portion 247a1 is responsible for the movement of a large part of the toner 290 within the storage chamber 246 (FIG. 19). An initial stage of the first contact period in which the sheet portions 247a1 and 247a2 have not yet reached approximately the same height is a period during which, in the storage chamber 246, the amount of the toner 290 held by the sheet portion 247a1 gradually decreases while the amount of the toner 290 held by the sheet portion 247a2 gradually increases. In other words, the initial stage of the first contact period is a transition period during which the state where the movement of the sheet portion 247a1 is predominantly responsible for the movement of the toner 290 within the storage chamber 246 is changed to a state where the movements of both the sheet portions 247a1 and 247a2 are responsible for the movement of the toner 290. During this period, the sheet portion 247a1 bends significantly due to contact with the protrusion 248, so that the posture of the sheet portion 247a1 becomes more stable. In addition, the timing at which the free end 247a11 of the sheet portion 247a1 reaches approximately the same height as the conveying support shaft 247b is delayed due to the deformation caused by contact with the protrusion 248, that is, the period during which the toner 290 is held by the sheet portion 247a1 whose posture has been stabilized is further extended. In order to cause the deformation of the sheet portion 247a1 due to contact with the protrusion 248 to occur at the earliest possible timing within the first contact period, the protrusion 248 is located lower than the rotational axis R of the conveying support shaft 247b.

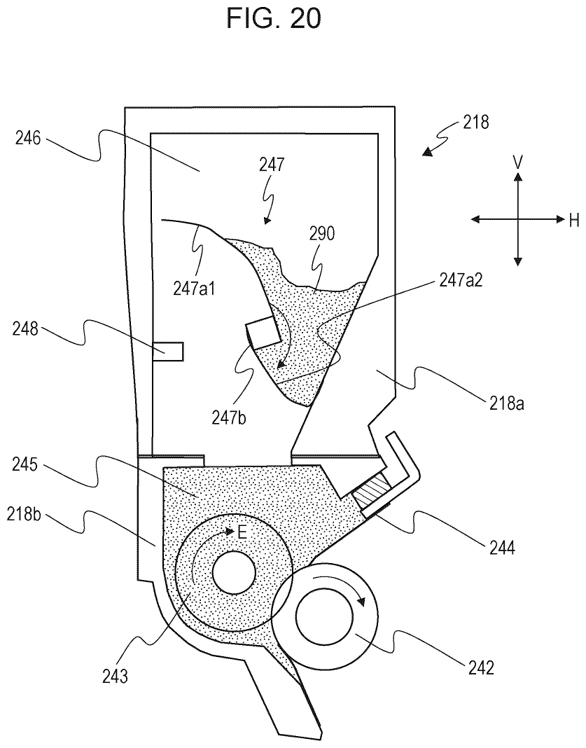

The second inner wall 382 includes an inclined surface that is inclined such that the distance between the first inner wall 381 and the second inner wall 382, which faces the first inner wall 381, in the horizontal direction gradually decreases with increasing distance downward from the conveying support shaft 247b in the direction of gravity. Due to this inclined surface, the cross-sectional area of a space that is formed between the second inner wall 382 and the conveying support shaft 247b and through which the sheet portion 247a2 passes is narrowest at a height below the rotational axis R. The timing at which the sheet portion 247a2 bends the most due to contact with the inclined surface of the second inner wall 382 occurs later than the timing at which the sheet portion 247a1 bends the most. This timing overlaps with the period during which the sheet portion 247a2 holds a large part of the toner 290 within the storage chamber 246 (see FIG. 20). The greater the bending of the sheet portion 247a2, the more stable its posture becomes.

As a result of the above-described effects, during a period in which the ratio of the amount of toner 290 handled by the sheet portion 247a1 to the amount handled by the sheet portion 247a2 gradually changes, the state in which the toner 290 is held by each of the sheet portions 247a changes stably. This enables a larger part of the toner 290 within the storage chamber 246 to be held more stably for a longer period of time by the inner walls of the storage chamber 246, the sheet portions 247a1 and 247a2, and the conveying support shaft 247b. Therefore, the influence of the weight of the toner 290 in the storage chamber 246 on the toner 290 in the developing chamber 245 can be reduced.

Here, in the present embodiment, the cross-sectional area of the space through which each of the sheet portions 247a passes at the closest position between the first inner wall 381 (the protrusion 248) and the conveying support shaft 247b is set to be approximately the same as the cross-sectional area of the space through which each of the sheet portions 247a passes at the closest position between the second inner wall 382 and the conveying support shaft 247b. Whether to set these cross-sectional areas of the spaces through which each of the sheet portions 247a passes to be approximately the same as each other, that is, whether to set the degree of the bending of each of the sheet portions 247a during contact with the protrusion 248 and the degree of the bending of each of the sheet portions 247a during contact with the second inner wall 382 to be approximately the same as each other or to be different from each other, may be suitably set in accordance with, for example, the apparatus specifications.

Regarding the configuration of the protrusion 248, the form of the protrusion 248 in the longitudinal direction, which is parallel to the direction in which the rotational axis R of the conveying support shaft 247b extends, is not limited to a specific form. For example, the protrusion 248 may be provided in a form that extends in the longitudinal direction to correspond to the longitudinal width of each of the sheet portions 247a1 and 247a2. Alternatively, the protrusion 248 may be provided with a longitudinal width shorter than the longitudinal width of each of the sheet portions 247a1 and 247a2 such that it partially contacts each of the sheet portions 247a1 and 247a2 in the longitudinal direction. Alternatively, the protrusion 248 may be divided into a plurality of portions in the longitudinal direction, that is, the plurality of protrusions 248 may be arranged in such a manner as to be spaced apart from each other along the longitudinal direction. In other words, the protrusion 248 may adopt various forms as long as it comes into contact with each of the sheet portions 247a1 and 247a2, which move in a direction against gravity while being in contact with the first inner wall 381, so as to temporarily increase the bending of the sheet portions 247a1 and 247a2 during their movement in the direction against gravity.

However, from the standpoint of the holding force exerted on the toner 290, a configuration in which the protrusion 248 extends in a continuous manner across the entire longitudinal length may be employed. When the end of the sheet portion 247a1 passes over the protrusion 248, the protrusion 248 functions as part of the portion that holds the toner 290. Thus, the protrusion 248 may be formed along the entire longitudinal length so as to minimize the space formed between the sheet portion 247a1 and the first inner wall 381 when the end of the sheet portion 247a1 passes over the protrusion 248. The protrusion 248 comes into contact with each of the sheet portions 247a along the entire longitudinal length, so that the amount of the toner 290 that spills from the sheet portion 247a1 when the end of the sheet portion 247a1 passes over the protrusion 248 is reduced, thereby enhancing the holding force exerted on the toner 290.

As indicated by the one-dot chain lines in FIG. 16, the protrusion 248 is provided at a position that does not overlap with the communication port F, that is, it is located away from the communication port F, when viewed in the direction of gravity.

As a result, for example, the toner 290 that spills when the end of each of the sheet portions 247a passes over the protrusion 248 falls directly into the communication port F, and entry of the spilled toner 290 into the developing chamber 245 is suppressed.

### Configuration of Toner Conveyance

The configuration for conveying the toner 290 within the storage chamber 246 to the developing chamber 245 will now be described in chronological order.

(1) The toner conveying member 247 is driven so as to rotate in a direction G (FIG. 19). Here, the movement of a large part of the toner 290 within the storage chamber 246 is handled by the sheet portion 247a1, which is one of the sheet portions 247a1 and 247a2. In this case, the amount of the toner 290 held on the upper surface (the surface on the upstream side in the rotational direction) of the sheet portion 247a2 is relatively small.

(2) The toner 290 in the vicinity of the communication port F is placed onto the upper side of the sheet portion 247a1 and conveyed (FIG. 18). Here, compared with the state described in (1), the amount of the toner 290 held on the upper surface of the sheet portion 247a2 increases. In other words, the difference between the amount of the toner 290 held on the upper surface (the surface on the downstream side in the rotational direction) of the sheet portion 247a1 and the amount of the toner 290 held on the upper surface (the surface on the upstream side in the rotational direction) of the sheet portion 247a2 is reduced more than that in the state described in (1). The sheet portion 247a1 is in a deformed state, having bent significantly due to contact with the protrusion 248, and thus, the sheet portion 247a1 can stably hold the toner 290.

(3) As a result of the conveying support shaft 247b being rotationally driven, the toner 290 that can no longer be supported by the upper side of the sheet portions 247a1 flows to the side on which the sheet portion 247a2 is present and is supported by the sheet portion 247a2 and the wall surface (the second inner wall 382) of the storage chamber 246 (FIG. 20). In this case, most of the weight of the toner 290 in the storage chamber 246 is applied to the sheet portion 247a2. However, the sheet portion 247a2 is in a deformed state, having bent significantly due to contact with the inclined surface of the second inner wall 382, and thus, the sheet portion 247a2 can stably hold the toner 290.

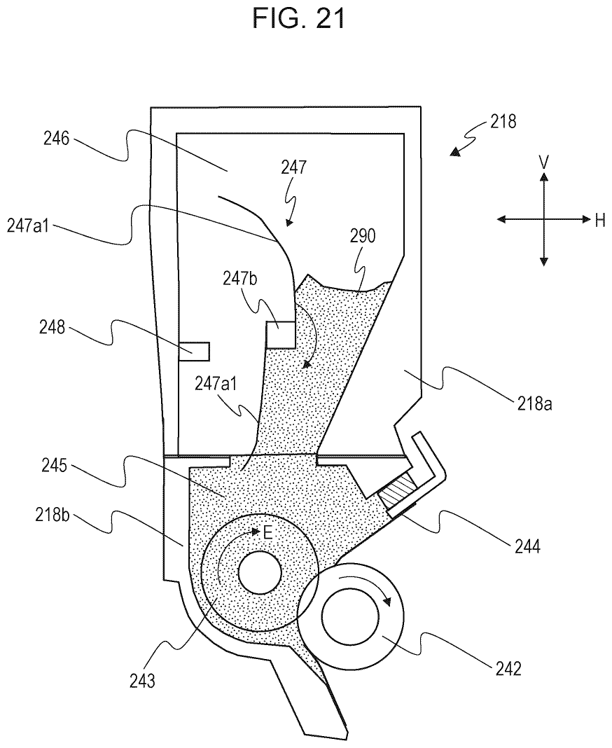

(4) As a result of the conveying support shaft 247b being rotationally driven, the toner 290 that can no longer be supported by the upper side of the sheet portions 247a2 flows into the vicinity of the communication port F through a gap formed between the wall surface (the second inner wall 382) of the storage chamber 246 and the sheet portion 247a2 (FIG. 21).

(5) The phase of the toner conveying member 247 returns to the phase described in (1) (FIG. 19).

In the present embodiment, although the first inner wall 381 is a surface extending along the vertical direction, it may have an inclined surface similar to that of the second inner wall 382. Alternatively, although the second inner wall 382 has the inclined surface, it may be a surface extending along the vertical direction like the first inner wall 381.

In the present embodiment, although a configuration is employed in which the protrusion 248 serving as a protruding portion provided on a portion of the first inner wall 381 temporarily increases the bending of each of the sheet portions 247a, the present invention is not limited to this configuration. For example, as a smoothly continuous protruding portion formed by a combination of surfaces such as curved and inclined surfaces, the first inner wall 381 may have a surface shape with a partial constriction.

### Third Embodiment

A third embodiment of the present invention will now be described. Note that differences between the configuration in the second embodiment and the configuration in the third embodiment will be mainly described. In the third embodiment, components that are the same as those in the second embodiment are denoted by the same reference signs, and repeated descriptions thereof will be omitted.

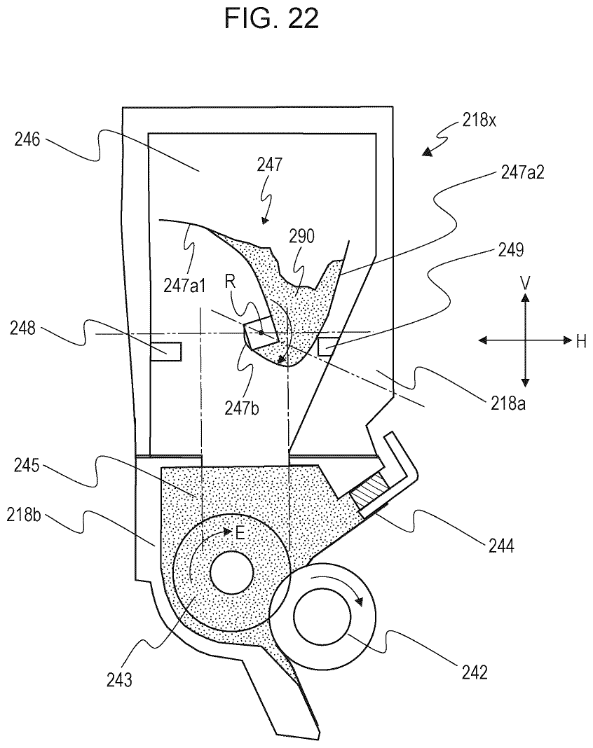

FIG. 22 is a diagram illustrating the configuration of the storage chamber 246 in the third embodiment. A frame body 218x in the third embodiment is characterized by including a protrusion 249 serving as a second protrusion in addition to the protrusion 248 serving as the first protrusion in the configuration of the second embodiment. Here, as viewed from the communication port F between the developing chamber 245 and the storage chamber 246, the protrusion 249 is positioned at a wall surface that is located on the downstream side in the direction of rotation of the toner conveying member 247. In other words, among the inner wall surfaces of the storage chamber 246, the second inner wall 382 with which each of the sheet portions 247a, which have passed through the communication port F, comes into contact after coming into contact with the first inner wall 381 is provided with the protrusion 249.

As indicated by a two-dot chain line in FIG. 22, a lower end surface of the protrusion 249 is located lower than the rotational center axis of the toner conveying member 247 (the rotational axis R of the conveying support shaft 247b). In addition, in the third embodiment, the protrusion 249 is disposed such that each of the sheet portions 247a moving in the direction of gravity comes into contact with the protrusion 249 during its movement in the direction (the second direction).

Here, as illustrated in FIG. 22, when each of the sheet portions 247a is driven so as to rotate in the direction of gravity while in contact with the protrusion 249, similar to the case of the protrusion 248, the stress against bending increases as the entire sheet portion 247a undergoes elastic deformation. This increases the holding force of the upper surface of the sheet portion 247a (the surface on the downstream side in the rotational direction) for holding the toner 290. Therefore, even when the sheet portion 247a is driven so as to rotate in the direction of gravity, the period during which the toner 290 is held on the upper surface of the sheet portion 247a is extended, and the accumulation of the toner 290 at the communication port F can be further suppressed.

As indicated by the two-dot chain line intersecting the second inner wall 382 in FIG. 22, the second inner wall 382 has an inclined surface, and if the protrusion 249 is not provided, the distance between the inclined surface and the rotational axis R of the conveying support shaft 247b is shortest at a position on the inclined surface, the position being located lower than the rotational axis R. That is to say, the cross-sectional area of a space that is located between the second inner wall 382 and the conveying support shaft 247b and through which each of the sheet portions 247a passes is narrowest at a position lower than the rotational axis R. It can be said that the two-dot chain line intersecting the second inner wall 382 in FIG. 22 is an imaginary line tracing the closest distance between the second inner wall 382 and the rotational axis R of the conveying support shaft 247b in the case where the protrusion 249 is not provided. The protrusion 249 is configured to locally narrow the space, which is located between the second inner wall 382 and the conveying support shaft 247b and through which each of the sheet portions 247a passes, to a greater degree. Thus, in the case where the toner 290 is not stored in the storage chamber 246, the bending of each of the sheet portions 247a, which occurs when the sheet portion 247a moves while being in contact with the second inner wall 382, temporarily reaches its maximum at the moment of contact with the protrusion 249. In other words, in the present embodiment, the distance between the second inner wall 382 and the rotational axis R of the conveying support shaft 247b in the direction perpendicular to the rotational axis R is shortest at the protrusion 249. Thus, the timing at which the bending of each of the sheet portions 247a reaches its maximum varies depending on the position at which the protrusion 249 is disposed. In the present embodiment, the protrusion 249 is located above the intersection point where the two-dot chain line meets the second inner wall 382 in FIG. 22.

As a result, along the path where each of the sheet portions 247a moves while in contact with the second inner wall 382, the timing at which the bending of each of the sheet portions 247a reaches its maximum is configured to occur earlier than it would if the protrusion 249 is not provided.

Here, in the present embodiment, in the first inner wall 381, the protrusion 248 is the closest portion to the conveying support shaft 247b. In the second inner wall 382, the protrusion 249 is the closest portion to the conveying support shaft 247b. In the present embodiment, the cross-sectional area of a space that is located between the protrusion 249 and the conveying support shaft 247b and through which each of the sheet portions 247a passes is set to be narrower than the cross-sectional area of a space that is located between the protrusion 248 and the conveying support shaft 247b and through which each of the sheet portions 247a passes. The degree of difference between the cross-sectional areas of the spaces through which each of the sheet portions 247a passes, that is, the difference in the degree of bending of each of the sheet portion 247a upon contact with the protrusion 248 and upon contact with the protrusion 249, may be suitably set in accordance with, for example, the apparatus specifications.

In some cases, there may be no difference between the cross-sectional areas of the spaces through which each of the sheet portions 247a passes.

As indicated by one-dot chain lines in FIG. 22, when viewed in the direction of gravity, the protrusion 249 is disposed at a position that does not overlap with the communication port F, that is, at a position located away from the communication port F.

### Modification 1

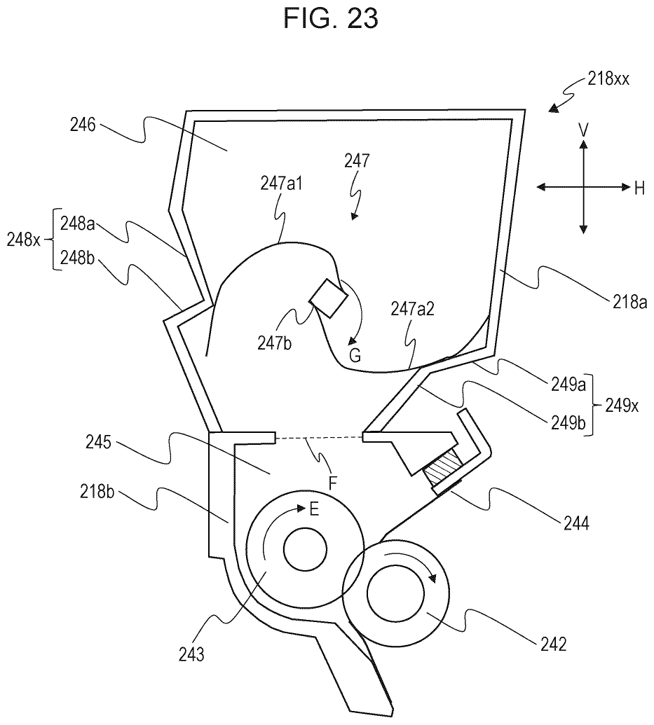

Note that the protrusions 248 and 249 in the present embodiment may be formed of wall-surface shapes as in a frame body 218xx according to Modification 1 illustrated in FIG. 23. More specifically, a protruding portion 248x that is formed by a wall surface 248a and a wall surface 248b illustrated in FIG. 23 serves as the first protrusion having the function of bending each of the sheet portions 247a when the sheet portion 247a is driven so as to rotate in the direction against gravity. Similarly, a protruding portion 249x that is formed by a wall surface 249a and a wall surface 249b serves as the second protrusion having the function of bending each of the sheet portions 247a when the sheet portion 247a is driven so as to rotate in the direction against gravity. The wall surfaces 248a, 248b, 249a, and 249b are surfaces each of which is parallel to the rotational axis R of the conveying support shaft 247b and are surfaces each of which extends in a continuous manner across the entire longitudinal length so as to come into contact with each of the sheet portions 247a throughout its entire longitudinal length (in the direction along the rotational axis R).

### Modification 2

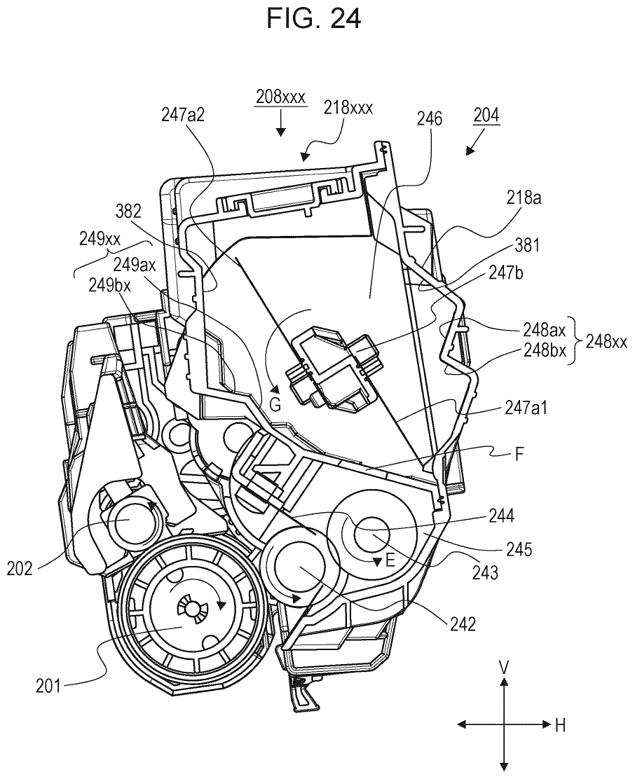

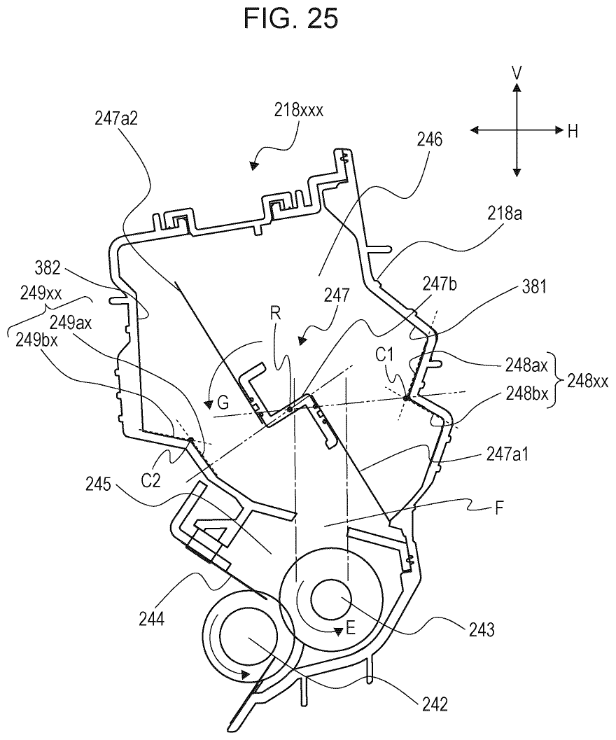

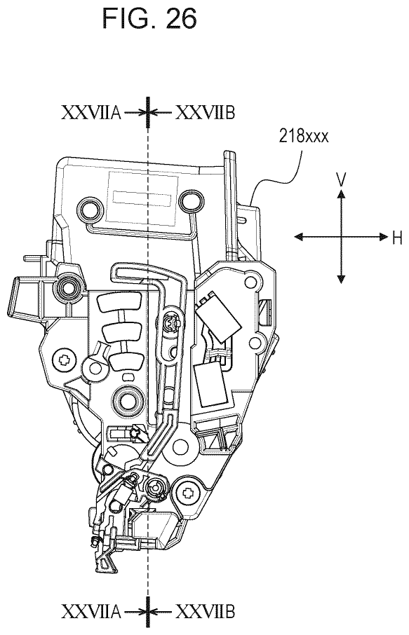

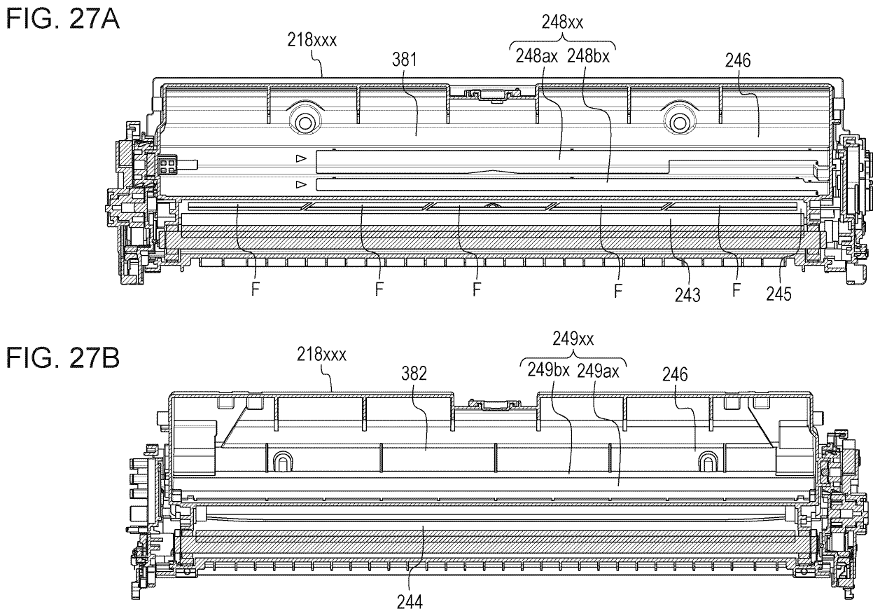

FIG. 24 is a cross-sectional view schematically illustrating a cross-sectional configuration of a process cartridge 208xxx according to Modification 2. FIG. 25 is a diagram illustrating a cross-sectional configuration of a frame body 218xxx of Modification 2 and is a diagram illustrating an end face configuration in the cross section of the frame body 218xxx in FIG. 24. FIG. 26 is a non-drive side view of a developing device according to Modification 2. FIG. 27A is a longitudinal sectional view of the developing device in Modification 2 and is a sectional view taken along line XXVIIA-XXVIIA of FIG. 26. FIG. 27B is a longitudinal sectional view of the developing device in Modification 2 and is a sectional view taken along line XXVIIB-XXVIIB of FIG. 26. The frame body 218xxx of Modification 2 includes a protruding portion 248xx provided at the first inner wall 381 and a protruding portion 249xx provided at the second inner wall 382, the protruding portion 248xx and the protruding portion 249xx serving as the first protrusion and the second protrusion, respectively. In other words, the protruding portion 248xx is formed by a wall surface 248ax and a wall surface 248bx and has a function of bending each of the sheet portions 247a when the sheet portion 247a is driven so as to rotate in the direction against gravity. The wall surface 248bx serves as an upstream side wall surface (a first upstream side wall surface) that is located on the upstream side in a movement direction of the sheet portions 247a. The wall surface 248ax serves as a downstream side wall surface (a first downstream side wall surface) that is located on the downstream side in the movement direction of the sheet portions 247a and that is continuous with the wall surface 248bx. The wall surface 248bx is a surface extending away from the rotational axis R of the conveying support shaft 247b toward the upstream side in the movement direction of the sheet portions 247a. The wall surface 248ax is a surface extending away from the rotational axis R of the conveying support shaft 247b toward the downstream side in the movement direction of the sheet portions 247a. Similarly, the protruding portion 249xx is formed by a wall surface 249ax and a wall surface 249bx and has a function of bending each of the sheet portions 247a when the sheet portion 247a is driven so as to rotate in the direction against gravity. The wall surface 249bx serves as an upstream side wall surface (a second upstream side wall surface) that is located on the upstream side in the movement direction of the sheet portions 247a. The wall surface 249ax serves as a downstream side wall surface (a second downstream side wall surface) that is located on the downstream side in the movement direction of the sheet portions 247a and that is continuous with the wall surface 248ax. The wall surface 249bx is a surface extending away from the rotational axis R of the conveying support shaft 247b toward the upstream side in the movement direction of the sheet portions 247a. The wall surface 249ax is a surface extending away from the rotational axis R of the conveying support shaft 247b toward the downstream side in the movement direction of the sheet portions 247a. The wall surfaces 248ax, 248bx, 249ax, and 249bx are surfaces each of which is parallel to the rotational axis R of the conveying support shaft 247b and are surfaces each of which extends in a continuous manner across the entire longitudinal length so as to have a portion that continuously comes into contact with each of the sheet portions 247a throughout its entire longitudinal length (in the direction along the rotational axis R).

As indicated by the two-dot chain line intersecting the protruding portion 248xx in FIG. 25, the distance between the protruding portion 248xx and the rotational axis R of the conveying support shaft 247b is shortest at an apex of the protruding portion 248xx (the boundary between the wall surface 248ax and the wall surface 248bx (also referred to as an intersection point C1) where an imaginary line that is indicated by a dashed line in FIG. 25 and that extends along the wall surface 248ax meets an imaginary line that is indicated by a dashed line in FIG. 25 and that extends along the wall surface 248bx). The apex of the protruding portion 248xx is located at a position higher than the rotational axis R. In addition, as indicated by the two-dot chain line intersecting the protruding portion 249xx in FIG. 25, the distance between the protruding portion 249xx and the rotational axis R of the conveying support shaft 247b in the direction perpendicular to the rotational axis R is shortest at the wall surface 249ax, which is located on the downstream side in the direction of rotation of the conveying support shaft 247b. An apex of the protruding portion 249xx (the boundary between the wall surface 249ax and the wall surface 249bx (also referred to as an intersection point C2) where an imaginary line that is indicated by a dashed line in FIG. 25 and that extends along the wall surface 249ax meets an imaginary line that is indicated by a dashed line in FIG. 25 and that extends along the wall surface 249bx) is located at a position lower than the rotational axis R.

### Comparative Validation

In order to confirm the effects of the embodiments of the present invention, validation was conducted by using the following comparative examples and the embodiments. Each configuration is illustrated in Table 1.

TABLE 1

| | Sheet Portion | Number of Protrusions |
|---|---|---|
| Comparative Example 1 | 1 | None |
| Comparative Example 2 | 1 | 1 |
| Comparative Example 3 | 2 | None |
| Second Embodiment | 2 | 1 |
| Third Embodiment | 2 | 2 |

### Comparative Example 1

In Comparative Example 1, a configuration is employed in which a single sheet portion is provided and in which a protrusion is not provided at the inner wall surface located on the downstream side in the direction of rotation of the sheet portion. The configuration, excluding the above, is similar to that in the second embodiment.

### Comparative Example 2

In Comparative Example 2, a configuration is employed in which a single sheet portion is provided. The configuration, excluding the above, is similar to that in the second embodiment.

### Comparative Example 3

In Comparative Example 3, a configuration is employed in which a protrusion is not provided at the inner wall surface located on the downstream side in the direction of rotation of the sheet portions. The configuration, excluding the above, is similar to that in the second embodiment.

### Validation

Durability tests were conducted in an environment with a temperature of 23° C. and a humidity of 50% by printing 1000 sheets with a printing ratio of 0.1% using developing containers of the above comparative examples. After that, halftone images were output to evaluate density unevenness.

### Validation Results

The validation results are illustrated in Table 2. The validation results were ranked based on the occurrence of density unevenness. A smaller numerical value indicates worse density unevenness. Ranks 1 and 2 were defined as unacceptable density unevenness. Rank 3 was defined as a level of density unevenness that does not cause a problem in practical use. Rank 4 was defined as a condition in which no density unevenness occurs. Each validation result will be described in detail below.

TABLE 2

| | Density Unevenness Rank |
|---|---|
| Comparative Example 1 | 1 |
| Comparative Example 2 | 2 |
| Comparative Example 3 | 2 |
| Second Embodiment | 3 |
| Third Embodiment | 4 |

First, the advantages of the embodiments of the present invention over Comparative Example 1 will be described. In the configuration of Comparative Example 1, unacceptable density unevenness was observed in the above evaluation.

In the configuration of Comparative Example 1, no protrusion is provided at the inner wall surface. Consequently, when the sheet portion rotates in the direction against gravity with the toner placed thereon, the sheet portion reaches a specific phase where an end part of the sheet portion bends due to the weight of the toner on the sheet portion. As a result, some of the toner on the sheet portion falls through a space between the end of the sheet portion and the inner wall surface. This causes the toner to easily accumulate in the vicinity of the opening. In addition, since Comparative Example 1 employs the configuration in which the single sheet portion is provided, when the sheet portion is rotationally driven and reaches a phase where it can no longer support the toner, the toner on the sheet portion falls downward in the vertical direction due to its own weight and immediately accumulates in the vicinity of the opening.

Due to these two factors, the accumulation amount of the toner in the vicinity of the opening increases, and this causes the toner in the temporary toner accumulation portion V to aggregate. As a result, the toner circulation in the temporary toner accumulation portion V becomes stagnant, making it difficult for the supply roller 243 to discharge the toner. Consequently, unacceptable halftone (HT) density unevenness occurred.

Next, the advantages of the embodiments of the present invention over Comparative Example 2 will be described. In the configuration of Comparative Example 2, unacceptable density unevenness was observed in the above evaluation.

In the configuration of Comparative Example 2, since the inner wall surface is provided with the protrusion, when the end of the sheet portion reaches the protrusion, the sheet portion is rotationally driven while bending moderately. Thus, by bending the entire sheet portion significantly, the sheet portion can be rotationally driven while supporting the toner for a longer period of time. This ensures a sufficient amount of toner removal from the vicinity of the opening, thereby suppressing the accumulation of the toner in the vicinity of the opening.

On the other hand, since the configuration includes the single sheet portion, when the sheet portion is rotationally driven to the phase where it can no longer support the toner placed thereon, the toner immediately falls due to its own weight and is supplied to and accumulates in the vicinity of the opening. As a result, although the toner accumulation was somewhat suppressed compared with Comparative Example 1, the suppression was insufficient, so that unacceptable levels of HT density unevenness occurred.

Next, the advantages of the embodiments of the present invention over Comparative Example 3 will be described. In the configuration of Comparative Example 3, unacceptable density unevenness was observed in the above evaluation.

In the configuration of Comparative Example 3, no protrusion is provided at the inner wall surface. Consequently, when each of the sheet portions rotates in the direction against gravity with the toner placed thereon, the sheet portion reaches a specific phase where the end part of the sheet portion bends due to the weight of the toner on the sheet portion. As a result, some of the toner on the sheet portion falls through the space between the end of the sheet portion and the inner wall surface. This causes the toner to easily accumulate in the vicinity of the opening. As a result, the amount of the toner removed from the vicinity of the opening becomes insufficient, and the toner accumulates in the vicinity of the opening.

On the other hand, since the two sheet portions are provided, even when one of the sheet portion is rotationally driven and reaches a phase where it can no longer support the toner, causing the toner to fall downward in the vertical direction due to its own weight, the other sheet portion blocks the falling toner. This suppresses direct accumulation of the toner in the vicinity of the opening.

As a result, in Comparative Example 3, although the toner accumulation was somewhat suppressed compared with Comparative Example 1, it was not sufficient, so that unacceptable levels of HT density unevenness occurred.

Next, the advantages of the second embodiment will be described. In the configuration of the second embodiment, although density unevenness was observed in the above evaluation, the level of density unevenness was a level of density unevenness that does not cause a problem in practical use.

In the configuration of the second embodiment, since the single protrusion is provided at the inner wall surface, when the end of each of the sheet portions reaches the protrusion, the sheet portion is rotationally driven while bending moderately. Thus, by bending the entire sheet portion significantly, the sheet portion can be rotationally driven while supporting the toner for a longer period of time. This ensures a sufficient amount of toner removal from the vicinity of the opening, thereby suppressing the accumulation of the toner in the vicinity of the opening.

In addition, since the two sheet portions are provided, even when one of the sheet portion is rotationally driven and reaches a phase where it can no longer support the toner, causing the toner to fall downward in the vertical direction due to its own weight, the other sheet portion blocks the falling toner. This suppresses direct accumulation of the toner in the vicinity of the opening.

As a result, in the configuration of the second embodiment, toner accumulation in the vicinity of the opening was suppressed to a certain extent, and only density unevenness at a level that does not cause a problem in practical use occurred.

Next, the advantages of the third embodiment will be described. In the configuration of the third embodiment, no density unevenness was observed in the above evaluation.

In the configuration of the third embodiment, since the protrusions are provided at the inner wall surfaces, when the end of each of the sheet portions reaches the protrusion, the sheet portion is rotationally driven while bending moderately. Thus, by bending the entire sheet portion significantly, the sheet portion can be rotationally driven while supporting the toner for a longer period of time. This ensures a sufficient amount of toner removal from the vicinity of the opening, thereby suppressing the accumulation of the toner in the vicinity of the opening.

In addition, since the two sheet portions are provided, even when one of the sheet portion is rotationally driven and reaches a phase where it can no longer support the toner, causing the toner to fall downward in the vertical direction due to its own weight, the other sheet portion can block the falling toner.

Furthermore, since the second protrusion is provided, when the toner falling from above is supported by the other sheet portion, by bending the entire sheet portion significantly, the sheet portion is rotationally driven while supporting the toner for a longer period of time. This suppresses direct accumulation of the toner in the vicinity of the opening. As a result, toner accumulation in the vicinity of the opening was sufficiently suppressed, and no HT density unevenness occurred.

The configurations of the above-described embodiments may be combined.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2024-055648, filed Mar. 29, 2024, and Japanese Patent Application No. 2024-057908, filed Mar. 29, 2024, which are hereby incorporated by reference herein in its entirety.

What is claimed is:

1. A cartridge configured to be installed in an image forming apparatus and used for image formation, the cartridge comprising:
a storage chamber that stores a toner;
a developing roller that is configured to be rotatable and that carries the toner;
a supply roller that is configured to be rotatable and that supplies the toner to the developing roller;
a developing chamber that communicates with the storage chamber via an opening and in which the developing roller and the supply roller are arranged; and
a stirring member that is disposed in the storage chamber and that stirs the toner,
wherein the stirring member includes
a stirring shaft that rotates,
a first stirring sheet member that is sheet-shaped, with one end fixed to the stirring shaft and another end being a free end, and
a second stirring sheet member that is sheet-shaped, with one end fixed to the stirring shaft and another end being a free end,
wherein when viewed in a rotational axis direction of the stirring shaft, and when the cartridge is in a posture in which the cartridge is installed in the image forming apparatus and used for image formation,
the developing chamber is positioned below the storage chamber,
at least a portion of the opening is located above the supply roller,
the stirring shaft is located above the opening,
the second stirring sheet member is provided on a side opposite to the first stirring sheet member with respect to an imaginary line passing through a center of rotation of the stirring shaft, and
the first stirring sheet member and the second stirring sheet member each have a length that allows the other ends thereof to reach the opening when the stirring shaft rotates.

2. The cartridge according to claim 1,
wherein the first stirring sheet member and the second stirring sheet member are each a sheet that is made of polycarbonate or polyphenylene sulfide and that has a thickness of 50 μm or more and 200 μm or less.

3. The cartridge according to claim 1,
wherein, when the stirring member rotates about the center of rotation,
the first stirring sheet member and the second stirring sheet member each come into contact with an inner wall of the storage chamber in a first phase, and
the first stirring sheet member comes into contact with the inner wall of the storage chamber, and the second stirring sheet member does not come into contact with the inner wall of the storage chamber in a second phase.

4. The cartridge according to claim 3,
wherein the stirring member further includes a sealing member that is sheet-shaped,
wherein the sealing member has one end fixed to the first stirring sheet member and another end capable of sealing the opening when the sealing member is in an unused state,
wherein the sealing member has a width shorter than a width of the first stirring sheet member in the rotational axis direction of the stirring shaft, and
wherein the sealing member has a thickness thinner than a thickness of the first stirring sheet member.

5. The cartridge according to claim 4,
wherein the sealing member is fixed to the first stirring sheet member by a double-sided adhesive tape, and
wherein the first stirring sheet member and the second stirring sheet member are fixed to the stirring shaft by heat staking.

6. A developing device comprising:
a frame body having a developing chamber and a storage chamber that is positioned above the developing chamber and that communicates with the developing chamber via an opening, the storage chamber being configured to store a toner;
a toner carrying member that is rotatably disposed in the developing chamber and that carries the toner;
a toner supply member that is rotatably disposed in the developing chamber and that supplies the toner to the toner carrying member;
a rotary shaft that is disposed in the storage chamber in such a manner as to be rotatable about a rotational axis of the rotary shaft;
a first sheet member that has flexibility, with one end and another end in a direction crossing the rotational axis being a first free end and a first fixed end, respectively, the first fixed end being fixed to the rotary shaft; and
a second sheet member that has flexibility, with one end and another end in the direction crossing the rotational axis being a second free end and a second fixed end, respectively, the second fixed end being fixed to the rotary shaft at a position different from a position at which the first fixed end is fixed to the rotary shaft,
wherein an inner wall of the storage chamber includes a first inner wall located on one side of the rotary shaft and a second inner wall located on another side of the rotary shaft in a horizontal direction,
wherein the first sheet member is fixed to the rotary shaft such that there is a first contact period during which the first free end is in contact with the first inner wall while the first sheet member moves in the storage chamber in a direction against gravity due to rotation of the rotary shaft,
wherein the second sheet member is fixed to the rotary shaft such that there is a second contact period during which the second sheet member moves in the storage chamber in a direction of gravity while the first sheet member moves in the direction against gravity due to rotation of the rotary shaft and during which the second free end is in contact with the second inner wall while the second sheet member moves in the direction of gravity, and
wherein the first inner wall is provided with a protrusion that comes into contact with the first sheet member so as to temporarily increase bending of the first sheet member during the first contact period.

7. The developing device according to claim 6,
wherein the protrusion is positioned below the rotary shaft in the direction of gravity.

8. The developing device according to claim 7,
wherein a distance between the first inner wall and the rotational axis in a direction perpendicular to the rotational axis is shortest at the protrusion.

9. The developing device according to claim 6,
wherein the first contact period and the second contact period at least partially overlap with each other.

10. The developing device according to claim 9,
wherein, in a period in which the first contact period and the second contact period overlap with each other, the storage chamber is partitioned into upper and lower spaces by the rotary shaft, the first sheet member, and the second sheet member.

11. The developing device according to claim 6,
wherein, when the first sheet member moves due to rotation of the rotary shaft in a state where a toner is not stored in the storage chamber, bending of the first sheet member that occurs at least during the first contact period becomes greatest when the first sheet member comes into contact with the protrusion.

12. The developing device according to claim 6,
wherein the rotary shaft overlaps with the opening when viewed in the direction of gravity.

13. The developing device according to claim 6,
wherein the opening and the toner supply member overlap with each other when viewed in the direction of gravity.

14. The developing device according to claim 6,
wherein the protrusion does not overlap with the opening when viewed in the direction of gravity.

15. The developing device according to claim 6,
wherein a distance between the first inner wall and the second inner wall, which face each other, in the horizontal direction gradually decreases with increasing distance downward from the rotary shaft in the direction of gravity.

16. The developing device according to claim 6,
wherein the protrusion has surfaces each of which is parallel to the rotational axis when viewed in a direction in which the rotational axis extends, and
wherein the protrusion includes an upstream side wall surface that extends away from the rotational axis toward an upstream side in a direction of movement of the first sheet member during the first contact period and a downstream side wall surface that extends away from the rotational axis toward a downstream side at a position downstream of the upstream side wall surface in the direction of movement and that is continuous with the upstream side wall surface.

17. The developing device according to claim 16,
wherein, when viewed in a direction in which the rotational axis extends, a distance between the protrusion and the rotational axis is shortest at an intersection point where an imaginary line extending along the upstream side wall surface meets an imaginary line extending along the downstream side wall surface.

18. The developing device according to claim 17,
wherein the intersection point is located at a position higher than the rotational axis.

19. The developing device according to claim 16,
wherein the protrusion includes a portion that continuously comes into contact with the first sheet member along the direction in which the rotational axis extends.

20. The developing device according to claim 16,
wherein the protrusion serves as a first protrusion, and
wherein the second inner wall is provided with a second protrusion that comes into contact with the second sheet member so as to temporarily increase bending of the second sheet member during the second contact period.
